(19) United States
(12) Patent Application Publication
(10) Pub. No.: US 2016/0238833 A1
(43) Pub. Date: Aug. 18, 2016

(54) INTERFACE APPARATUS, MODULE, CONTROL COMPONENT, CONTROL METHOD, AND PROGRAM STORAGE MEDIUM

(71) Applicant: NEC Corporation, Tokyo (JP)

(72) Inventor: Fujio OKUMURA, Tokyo (JP)

(21) Appl. No.: 15/025,965

(22) PCT Filed: Oct. 1, 2014
(86) PCT No.: PCT/JP2014/005017

§ 371 Date: Mar. 30, 2016

(30) Foreign Application Priority Data
Oct. 2, 2013 (JP) 2013-207107

(51) Int. Cl. G02B 26/06; G06F 1/16; G06F 3/01; H04N 5/225; H04N 9/31

(52) U.S. Cl. CPC G02B 26/06; H04N 5/2256; H04N 9/3173; G06F 3/017; G06F 1/1639; G06F 1/1643; G06F 1/163; G06F 1/1673; G06F 1/1684

(57) ABSTRACT

Provided is a technology of projecting bright images at one time in a plurality of directions by means of a projector which is small and light weight. An interface apparatus is provided with: a laser source that radiates laser light; an element that modulates the phase of inputted laser light, and outputs the light; an image unit that captures a subject; and a control unit, which detects the subject captured by means of the image unit, determines, based on the results of the recognition, an image to be formed based on the light outputted from the element, and controls the element such that the determined image is formed.

### TECHNICAL FIELD

The present invention relates to an interface apparatus, a module, a control component, a control method, and a program storage medium.

### BACKGROUND ART

In recent years, interface apparatuses in which an image recognition device such as a camera, and a projector are combined have been developed. These interface apparatuses (user interface apparatuses or man-machine interface apparatuses) capture an object, and a gesture by a hand or a finger with the camera. Then, these interface apparatuses identify or detect the captured object by image processing, or detect the captured gesture by image processing. Furthermore, these interface apparatuses determine what picture image is projected from a projector based on the information in accordance with a result of the image processing.

In addition, these interface apparatuses read, thereby can acquire as input information the gesture by a hand or a finger with respect to an image projected by a projector. Examples of these interface apparatuses are described in NPL 1 to 3.

In the interface apparatus as described above, a projector is an important component. In order to reduce the interface apparatus in size and weight, the projector needs to be reduced in size and weight. At the present day, a compact and lightweight projector like this is called a picoprojector.

Here, reducing the projector in size and weight and making output of the projector larger is a trade-off relationship. For example, a picoprojector disclosed in NPL 4 has the brightness of output (i.e. image to be projected) that is in the highest category among picoprojectors, and has the size that is also in the biggest category among picoprojectors. Specifically, the projector has a volume of 160 cm³ and a weight of 200 g. The projector outputs a light flux of 33 lm (lumen) by a 12 W (watt) LED (Light Emitting Diode) light source. In contrast, a picoprojector disclosed in NPL 5 is more reduced in size and weight compared to the projector disclosed in NPL 4, but the brightness of output is about half of that of the projector disclosed in NPL 4. Specifically, the projector disclosed in NPL 5 has a volume of 100 cm³, a weight of 112 g, a power consumption of 4.5 W, and a brightness of 15 lm, according to specifications included in the same literature.

### CITATION LIST

### Patent Literature

[PTL 1] JP 2003-140108 A

[PTL 2] JP 2006-267887 A

[PTL 3] JP 2006-285561 A

### Non Patent Literature

[NPL1] Pranav Mistry, “SixthSense”, MIT Media Lab, [Sep. 12, 2013, Search], Internet (URL:http://www.pranavmistry.com/projects/sixthsense)

[NPL2] Hrvoje Benko, Scott Saponas, “Omnitouch”, Microsoft, [Sep. 12, 2013, Search], Internet (URL: http://research.microsoft.com/en-us/news/features/touch-101711.aspx)

[NPL3] NEC, Mobile World Congress 2012, [Sep. 12, 2013, Search], Internet (URL: http://www.nec.com/en/event/mwc/movie.html)

[NPL4] “Compact Projector GP-091 Manufactured by Shenzhen YSF”, [Sep. 12, 2013 Search], Internet (URL:http://trade.e-to-china.com/product-p1A6DEA1/Mini_led_Lcos_projector_GP_091_Portable_home_theater_Projector.html)

[NPL5] “Compact Laser Projector Manufactured by Microvision”, [Sep. 12, 2013, Search], Internet (URL: http://www.itmedia.co.jp/lifestyle/articles/1107/06/news098.html)

[NPL6] “Performance of Projector Used for Sixthsense”, [Sep. 12, 2013, Search], Internet (URL:http://www.picopros.com/article/sixthsense-technology-using-microvision-picop% C2%AE-technology)

[NPL7] Kashiko Kodate, Takeshi Kamiya, “Numerical Analysis of Diffractive Optical Element and Application Thereof”, MARUZEN PUBLISHING CO., LTD, December 2011, pp. 175-179

### SUMMARY OF INVENTION

### Technical Problem

The present inventor studied, in a compact and lightweight projector, a method for projecting bright picture images on a plurality of places where the picture images should be displayed. As described above, at the present day, in a projector, reducing size and weight and brightening a picture image is a trade-off relationship. A current picoprojector can only be used at a close range and in a place where intensity of environmental light is weak because a picture image that can be displayed is darkened due to needs of reducing size and weight.

However, a range of use required for the above-described interface apparatus is not limited to a close range. More specifically, a user sometimes wants to use the interface apparatus like this for displaying a picture image on an object a short distance away, or for displaying an image on a table. However, when an existing projector is used in a situation where a projection distance is long in that manner, a picture image projected by the projector becomes dark, and thus, it is difficult to see the projected picture image.

Here, by narrowing down a direction where a projector projects a picture image, an apparatus disclosed in NPL 3 can brighten a picture image to be displayed. However, since the projecting direction of the picture image is narrowed down, the apparatus becomes less able to project picture images at one time in a plurality of directions.

The present invention has been made in view of the above-described problem. A main object of the present invention is to provide a technology capable of projecting bright images at one time in a plurality of directions, in a compact and lightweight projector.

### Solution to Problem

An interface apparatus according to an exemplary aspect of the present invention includes:
a laser source that radiates laser light;
an element that modulates a phase of incident laser light by the laser source and emits modulated laser light;
an imaging device that captures an image of a subject; and
a control unit that detects the subject captured by the imaging device, determining an image to be formed by the laser light emitted from the element based on a detected result, and controlling the element such that a determined image is formed.

A module according to an exemplary aspect of the present invention includes:
a laser source that radiates laser light;
an element that modulates a phase of incident laser light by the laser source and emits modulated laser light; and
a control unit that controls the element,
wherein the control unit determines an image to be formed by the modulated laser light emitted from the element and controls the element such that a determined image is formed based on a detected result by processing unit included in an electronic device, the electronic device further including an imaging device that captures an image of a subject, the processing unit detecting the subject captured by the imaging device.

An electronic component according to an exemplary aspect of the present invention includes:
a control unit that controls an electronic device, the electronic device including a laser source that radiates laser light, an element that modulates a phase of incident laser light by the laser source and emits modulated laser light, an imaging device that captures an image of a subject, and processing a for detecting the subject captured by the imaging device,
wherein the control unit determines an image to be formed by the emitted laser light of the element based on a detected result by the processing unit, and controls the element such that the determined image is formed.

A control method by a computer according to an exemplary aspect of the present invention includes:
detecting a subject captured by an imaging device included in an interface apparatus, the interface apparatus including a laser source that radiates laser light, and an element that modulates a phase of incident laser light by the laser source and emits modulated laser light, the imaging device capturing an image of the subject;
determining an image to be emitted from the element based on a detected result; and
controlling the element such that a determined image is formed.

A program storage medium according to an exemplary aspect of the present invention storing a computer program which makes a computer execute a set of processing to control an interface apparatus, the interface apparatus including a laser source that radiates laser light, an element that modulates a phase of incident laser light by the laser source and emits modulated laser light, and an imaging device that captures an image of a subject, the set of processing includes:
detecting the subject captured by the imaging device;
determining an image to be formed by the laser light emitted from the element based on a detected result; and
controlling the element such that a determined image is formed.

It is to be noted that the main object of the present invention is also achieved by a control method corresponding to the interface apparatus of the present invention. In addition, the main object of the present invention is also achieved by a computer program corresponding to the interface apparatus of the present invention and the control method of the present invention, and a computer-readable program storage medium that stores the computer program.

### Advantageous Effects of Invention

According to the present invention, bright images can be projected at one time in a plurality of directions, in a compact and lightweight projector.

### BRIEF DESCRIPTION OF DRAWINGS

FIG. 1 is a block diagram illustrating an interface apparatus according to a first exemplary embodiment of the present invention.

FIG. 2 is a diagram describing a configuration of an element achieved by MEMS (Micro Electro Mechanical System).

FIG. 3 is a diagram exemplifying an image that laser light diffracted by the element forms.

FIG. 4 is a diagram illustrating an example of an optical system that achieves a projection unit according to the first exemplary embodiment.

FIG. 5 is a flow chart exemplifying an operation of the interface apparatus according to the first exemplary embodiment.

FIG. 6 is a diagram used for describing the operation of the interface apparatus according to the first exemplary embodiment.

FIG. 7 is a diagram illustrating an example of a hardware configuration capable of achieving a control unit according to the first exemplary embodiment.

FIG. 8 is a diagram illustrating a wristband in which the interface apparatus according to the first exemplary embodiment is implemented.

FIG. 9 is a diagram illustrating a person who uses the interface apparatus according to the first exemplary embodiment with the interface apparatus been in his/her chest pocket.

FIG. 10 is a diagram illustrating eyeglasses or the like in which the interface apparatus according to the first exemplary embodiment is implemented.

FIG. 11 is a diagram illustrating a person who uses a terminal in which the interface apparatus according to the first exemplary embodiment is implemented with the terminal dangled around the neck.

FIG. 12 is a diagram illustrating an example of a tablet terminal in which the interface apparatus according to the first exemplary embodiment is implemented.

FIG. 13 is a diagram illustrating an example of a smartphone in which the interface apparatus according to the first exemplary embodiment is implemented.

FIG. 14 is a diagram illustrating a mode in which the interface apparatus according to the first exemplary embodiment is applied to a translation support device.

FIG. 15 is a diagram illustrating a mode in which the interface apparatus according to the first exemplary embodiment is applied to a work support device.

FIG. 16 is a diagram illustrating a mode in which the interface apparatus according to the first exemplary embodiment is applied to the work support device.

FIG. 17 is a diagram illustrating a mode in which the interface apparatus according to the first exemplary embodiment is applied to a support device of book returning.

FIG. 18 is a diagram illustrating a mode in which the interface apparatus according to the first exemplary embodiment is applied to a vehicle antitheft device.

FIG. 19 is a diagram illustrating a mode in which the interface apparatus according to the first exemplary embodiment is applied to a medical device.

FIG. 20 is a diagram illustrating a mode in which the interface apparatus according to the first exemplary embodiment is applied to a medical device.

FIG. 21 is a diagram illustrating a mode in which the interface apparatus according to the first exemplary embodiment is applied to an emergency medical device.

FIG. 22 is a diagram illustrating a mode in which the interface apparatus according to the first exemplary embodiment is applied to support of product replacement work.

FIG. 23 is a diagram illustrating a mode in which the interface apparatus according to the first exemplary embodiment is applied to support of work to select a product.

FIG. 24 is a diagram illustrating a mode in which the interface apparatus according to the first exemplary embodiment is applied to support of a presentation in a meeting room.

FIG. 25 is a diagram illustrating a state in which the interface apparatus according to the first exemplary embodiment is applied to creation of a meeting environment at a visiting destination.

FIG. 26 is a diagram illustrating a mode in which the interface apparatus according to the first exemplary embodiment is applied to an entering/leaving management system.

FIG. 27 is a diagram illustrating a mode in which the interface apparatus according to the first exemplary embodiment is applied to support of a delivery business.

FIG. 28 is a block diagram illustrating a module according to a second exemplary embodiment of the present invention.

FIG. 29 is a block diagram illustrating a control component according to a third exemplary embodiment of the present invention.

FIG. 30 is a block diagram illustrating an interface apparatus according to a fourth exemplary embodiment of the present invention.

### DESCRIPTION OF EMBODIMENTS

Hereinafter, exemplary embodiments according to the present invention will be described using drawings. It is to be noted that, in all drawings, the same components are denoted by the same reference numerals, and the description is appropriately omitted.

It is to be noted that, in the following description, each component of each apparatus represents a block of a functional unit rather than a configuration of a hardware unit. Each component of each apparatus is achieved by an combination of hardware and software focusing on a CPU (Central Processing Unit), a memory, a program that achieves components, a storage medium that stores the program, and an interface for network connection of a computer. There are various modifications in the achievement method and apparatuses thereof. However, each component may be configured by a hardware device. More specifically, each component may be configured by a circuit or a physical device.

### First Exemplary Embodiment

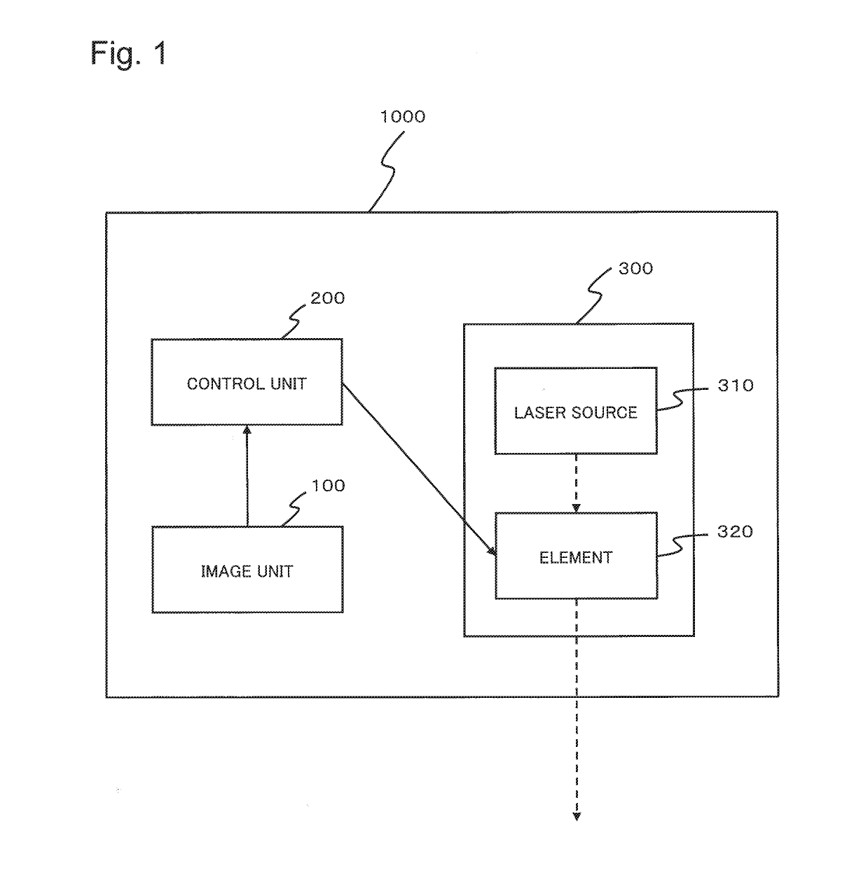

FIG. 1 is a block diagram illustrating a functional configuration of an interface apparatus of a first exemplary embodiment. In FIG. 1, a dotted line represents a flow of laser light, and a solid line represents a flow of information.

An interface apparatus 1000 includes an image unit 100, a control unit 200, and a projection unit 300. Hereinafter, each of the components (elements) will be described.

The projection unit 300 includes a laser source 310 and an element 320. The laser source 310 includes a configuration for radiating laser light. The laser source 310 and the element 320 are arranged such that laser light radiated by the laser source 310 is incident on the element 320. The element 320 includes a function of modulating a phase of the laser light and emitting a modulated light when the laser light is incident thereon. The projection unit 300 may further include an imaging optical system, a projecting optical system, or the like which is not illustrated in the drawing. The projection unit 300 projects an image formed by the laser light emitted from the element 320.

The image unit 100 inputs (incorporates) information of the subject, a movement thereof, or the like (hereinafter, also referred to as “subject or the like”) into the interface apparatus 1000 by capturing a subject that exists outside of the interface apparatus 1000. The image unit 100 is achieved by, for example, an imaging element, such as CMOS (Complementary Metal-Oxide Semiconductor), a three-dimensional depth detecting element, or the like.

The control unit 200 identifies or detects (hereinafter, referred to as “detect” without a distinction between identify and detect) the subject or the like captured by the image unit 100 by image processing such as pattern recognition (pattern detection). The control unit 200 controls the element 320 based on the detected result. More specifically, the control unit 200 determines an image projected by the projection unit 300 based on the detected result, and controls the element 320 such that the image formed by the laser light emitted from the element 320 becomes the determined image.

The control unit 200 and the element 320 in the first exemplary embodiment will be further described. The element 320 is achieved by a phase-modulation type diffractive optical element. The element 320 is also called a spatial light phase modulator or a phase-modulation type spatial modulation element. Hereinafter, details will be described.

The element 320 includes a plurality of light-receiving regions (details will be described below). The light-receiving regions are cells that configure the element 320. The light-receiving regions are arranged, for example, in a one-dimensional or two-dimensional array. The control unit 200 controls each of the plurality of light-receiving regions that configure the element 320, based on control information, such that a parameter that determines a difference between a phase of light incident on the light-receiving region and a phase of light emitted from the light-receiving region is changed. Specifically, the control unit 200 controls each of the plurality of light-receiving regions such that optical properties, such as a refractive index and an optical path length, are changed. The distribution of the phase of the incident light incident on the element 320 is changed in accordance with the change of the optical properties of each of the light-receiving regions. Accordingly, the element 320 emits light reflecting the control information.

The element 320 has, for example, ferroelectric liquid crystal, homogeneous liquid crystal, or vertical-alignment liquid crystal, and is achieved by using, for example, a technology of LCOS (Liquid Crystal On Silicon). In this case, with respect to each of the plurality of light-receiving regions that configure the element 320, the control unit 200 controls a voltage to be applied to the light-receiving region. The refractive index of the light-receiving region is changed in accordance with the applied voltage. Thus, by controlling the refractive index of each of the light-receiving regions that configure the element 320, the control unit 200 can generate a difference of refractive indexes between the light-receiving regions. In the element 320, the incident laser light is appropriately diffracted in each of the light-receiving regions by the control of the control unit 200.

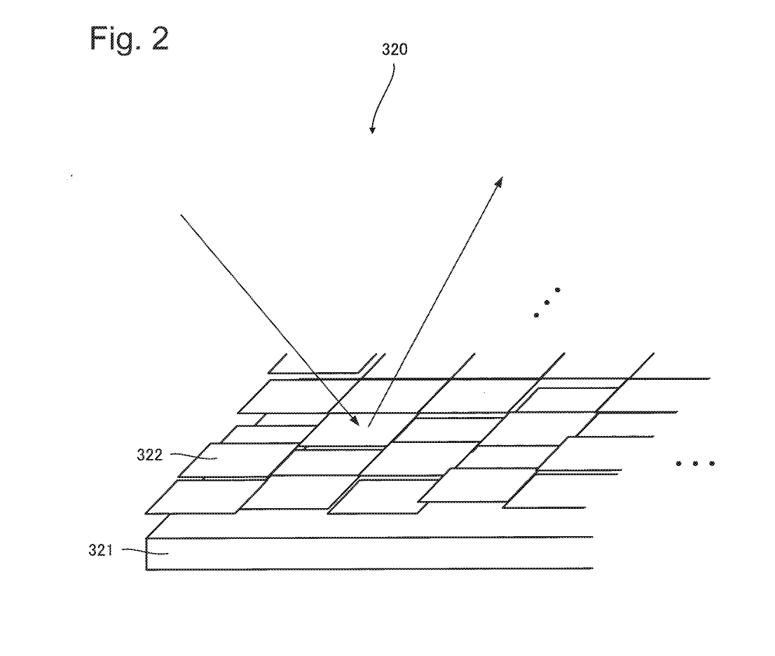

The element 320 can also be achieved by, for example, a technology of MEMS (Micro Electro Mechanical System). FIG. 2 is a diagram describing a configuration of the element 320 achieved by MEMS. The element 320 includes a substrate 321 and a plurality of mirrors 322 that are assigned to the respective light-receiving regions on the substrate. Each of the plurality of light-receiving regions of the element 320 is configured by the mirror 322. The substrate 321 is, for example, parallel to the light-receiving surface of the element 320, or substantially perpendicular to the incident direction of the laser light.

With respect to each of the plurality of mirrors 322 included in the element 320, the control unit 200 controls a distance between the substrate 321 and the mirror 322. Accordingly, for each of the light-receiving regions, the control unit 200 changes an optical path length when the incident light is reflected. The element 320 diffracts the incident light by the principle same as that of a diffraction grating.

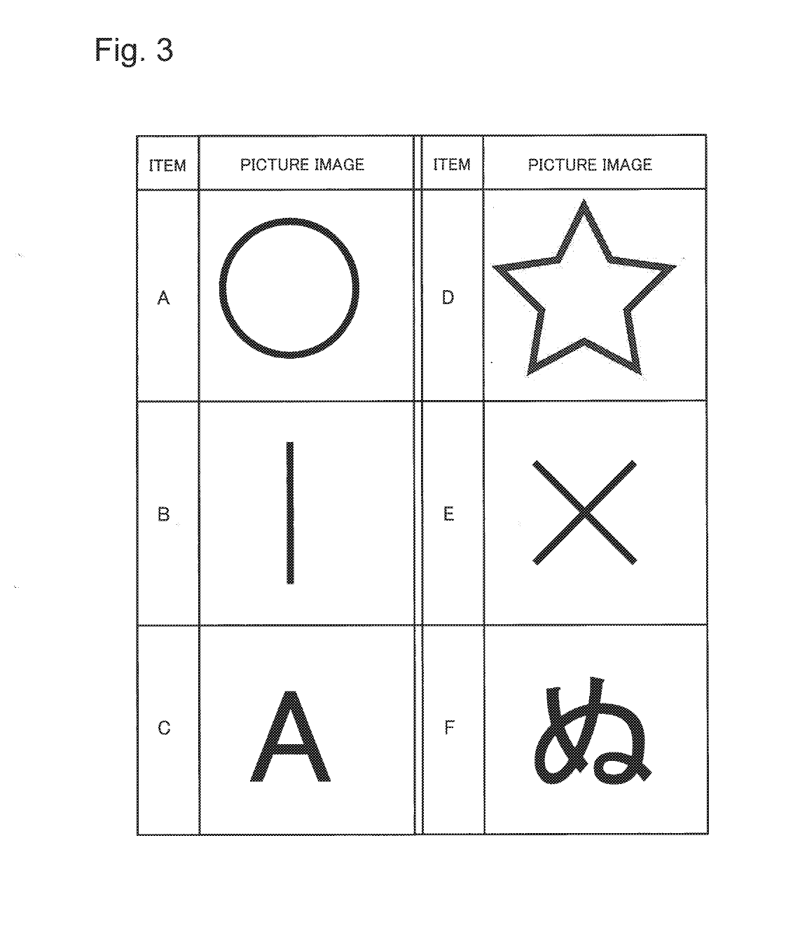

FIG. 3 is a diagram exemplifying an image that the laser light diffracted by the element 320 forms. The image formed by the laser light diffracted by the element 320 is, for example, a hollow graphic (Item A) or a linear graphic (Item B). In addition, the image formed by the laser light diffracted by the element 320 is a combination of a hollow graphic and a linear graphic, for example, an image having a shape, such as a character or a symbol (Item C, D, E, or F).

In theory, the element 320 can form any image by diffracting the incident laser light. The foregoing diffractive optical element is described in detail in NPL 7, for example. In addition, a method for forming an image by controlling the element 320 with the control unit 200 is described in NPL 8 below, for example. Thus, the description is omitted here.

[NPL8] Edward Buckley, “Holographic Laser Projection Technology”, Proc, SID Symposium 70.2, pp. 1074-1079, 2008

A difference between an image that a usual projector projects and an image that the interface apparatus 1000 projects will be described. In the case of the usual projector, an image formed by an intensity-modulation type element is directly projected through a projection lens. In other words, the image formed by the intensity-modulation type element and the image that the usual projector projects have a similarity relationship. The image projected from the projector is widened, and the brightness of the image becomes dark in inverse proportion to the square of the distance.

In contrast, in the case of the interface apparatus 1000, a pattern of the refractive index or a pattern of the height of the mirror in the element 320 and the image formed based on the light emitted from the element 320 have a non-similarity relationship. In the case of the interface apparatus 1000, the light incident on the element 320 is diffracted and is Fourier transformed with a lens, and the image determined by the control unit 200 is formed. The element 320 can concentrate the light on only a desired part in accordance with the control by the control unit 200. Regarding the image that the interface apparatus 1000 projects, a light flux of the laser light diffuses in a partially aggregated state. Accordingly, the interface apparatus 1000 can project a bright image also on a distant object.

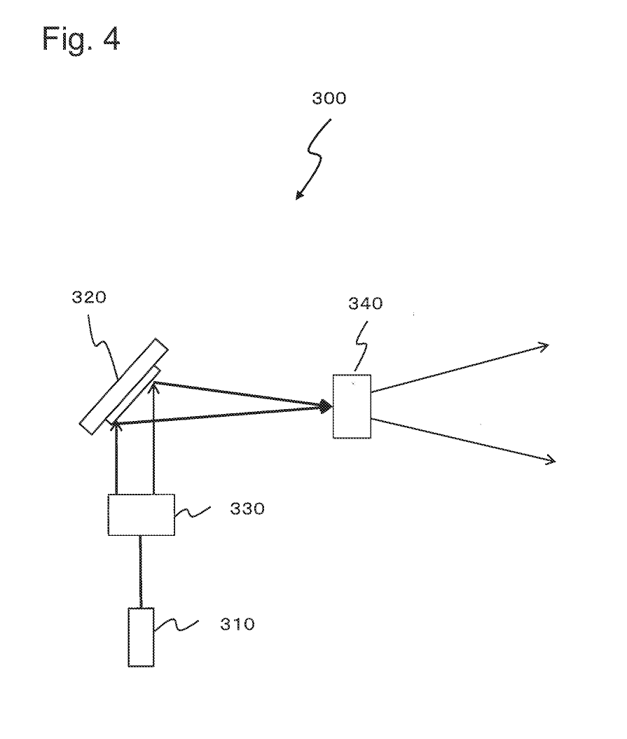

FIG. 4 is a diagram illustrating an example of an optical system that achieves the projection unit 300. The projection unit 300 can be achieved by, for example, the laser source 310, the element 320, a first optical system 330, and a second optical system 340.

The laser light radiated from the laser source 310 is shaped to a mode suitable for subsequent phase modulation by the first optical system 330. As a specific example, the first optical system 330 has, for example, a collimator, and the collimator makes the laser light be a mode suitable for the element 320 (i.e. parallel light). In addition, the first optical system 330 sometimes includes a function of adjusting polarization of the laser light so as to be suitable for the subsequent phase modulation. More specifically, in the case where the element 320 is a phase-modulation type, light having a polarization direction set in a production step needs to be radiated on the element 320. In the case where the laser source 310 is a semiconductor laser, light emitted from the semiconductor laser is polarized, and thus, the laser source 310 (semiconductor laser) may be arranged such that a polarization direction of light to be incident on the element 320 meets the set polarization direction. In contrast, in the case where the light emitted from the laser source 310 is not polarized, the first optical system 330 includes, for example, a polarization plate, and the polarization plate needs to be adjusted such that the polarization direction of the light to be incident on the element 320 meets the set polarization direction. In the case where the first optical system 330 includes the polarization plate, for example, the polarization plate is arranged closer to the side of the element 320 than the collimator. The laser light guided from the foregoing first optical system 330 toward the element 320 is incident on the light-receiving surface of the element 320. The element 320 has the plurality of light-receiving regions. The control unit 200 controls the optical properties (for example, refractive index) of each of the light-receiving regions of the element 320 in accordance with information of each pixel of an image to be projected, for example, by varying a voltage to be applied to each of the light-receiving regions. The laser light phase-modulated by the element 320 passes through a Fourier transform lens (not illustrated in the drawing), and moreover, is concentrated toward the second optical system 340. The second optical system 340 has, for example, a projection lens. The concentrated light is imaged by the second optical system 340, and is radiated to the outside.

It is to be noted that an example of the optical system that achieves the projection unit 300 using the reflection-type element 320 is illustrated in FIG. 4, but the projection unit 300 may be achieved using the transmission-type element 320.

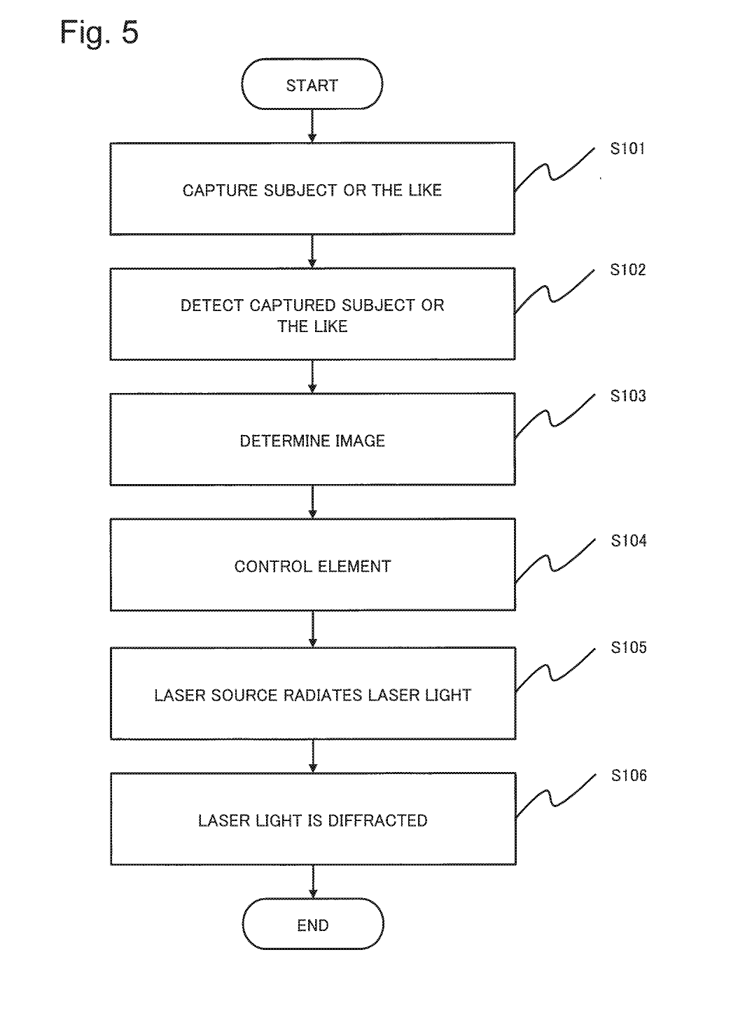

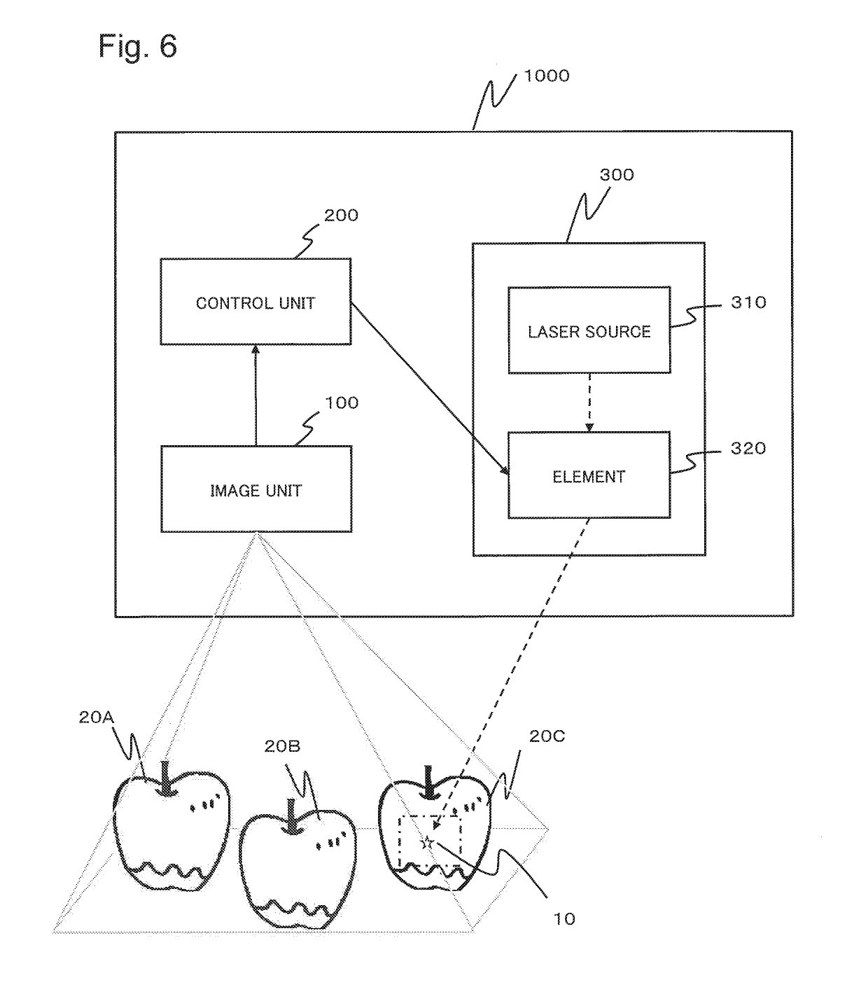

A flow of an operation by the interface apparatus 1000 according to the first exemplary embodiment will be described using FIG. 5 and FIG. 6. FIG. 5 is a flow chart describing the flow of the operation by the interface apparatus 1000 according to the first exemplary embodiment. FIG. 6 is a diagram describing the flow of the operation by the interface apparatus 1000 according to the first exemplary embodiment.

The image unit 100 inputs information of the subject, a movement thereof, or the like (hereinafter, also referred to as “subject or the like”) into the interface apparatus 1000 by capturing a subject that exists outside of the interface apparatus 1000 (Step S101). The term subject here is a product, such as a book, a food product, or a pharmaceutical product, or is a human body, a hand, or a finger. In the example of FIG. 6, the image unit 100 captures three apples 20A, 20B, and 20C that are the subject.

The control unit 200 detects a picture image captured by the image unit 100 (Step S102). For example, the control unit 200 detects a positional relationship between the own apparatus and the subject based on the picture image captured by the image unit 100.

The control unit 200 determines an image in which the projection unit 300 should project based on the picture image captured by the image unit 100 (Step S103). In the example of FIG. 6, it is assumed that the control unit 200 determines that a star-shaped image 10 is projected on the apple 20C among the three apples. The control unit 200 determines to project the image 10 such that a star-shaped mark is projected on the position of the apple 20C based on a positional relationship between the interface apparatus 1000 and the apple 20C.

It is to be noted that, hereinafter, in some cases, an image that the interface apparatus 1000 projects is shown by being surrounded with a dot-and-dash line in the drawing for the convenience of description.

The control unit 200 controls the optical properties (for example, refractive index) of each of the plurality of light-receiving regions included in the element 320 such that the determined image in the operation of Step S103 is formed over the determined position, for example, by varying a voltage to be applied to each of the light-receiving regions (Step S104). The laser source 310 radiates laser light (Step S105). In the element 320, incident laser light is diffracted (Step S106).

The operation of the interface apparatus 1000 is not limited to the above-described operation. Hereinafter, several modified examples of the above-described operation will be described.

The modified example of the order of the operation will be described. The interface apparatus 1000 may perform the control by the control unit 200 after the laser source 310 radiates laser light.

The modified example of the operation of Step S104 will be described. The control unit 200 does not always have to control the optical properties of all of the light-receiving regions among the plurality of light-receiving regions included in the element 320. The control unit 200 may be structured to control the optical properties of a part of the light-receiving regions among the plurality of light-receiving regions included in the element 320.

The modified example of the operation illustrated in Steps S103 and S104 will be described. The control unit 200 achieves the shape of the image to be projected on the subject by controlling the element 320, and the control unit 200 may control the second optical system 340 in the projection unit 300 such that the image is projected on the determined position.

The modified example of the operation illustrated in Step S102 and Step S103 will be described. The processing of determining the image to be projected by detecting the picture image captured by the image unit 100 may be performed by an external apparatus of the interface apparatus 1000. In this case, the image unit 100 and the control unit 200 operate as described below. The image unit 100 captures the subject and transmits the captured picture image to the external apparatus. The external apparatus detects the picture image and determines the image that the interface apparatus 1000 should project and the position on which the image should be projected. The external apparatus transmits the determined information to the interface apparatus 1000. The interface apparatus 1000 receives the information. The control unit 200 controls the element 320 based on the received information.

The modified example of the operation illustrated in Step S101 will be described. The interface apparatus 1000 does not always have to include the image unit 100 inside the own apparatus. The interface apparatus 1000 may receive a picture image captured by an external apparatus or may read the picture image from an external memory connected to the own apparatus (for example, USB (Universal Serial Bus), SD (Secure Digital) card, or the like).

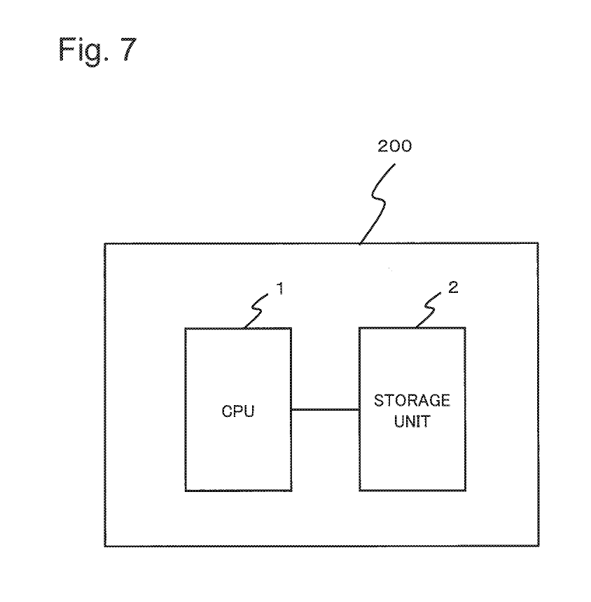

FIG. 7 is a diagram describing an example of a hardware configuration capable of achieving the control unit 200.

Hardware configuring the control unit 200 (computer) includes a CPU (Central Processing Unit) 1 and a storage unit 2. The control unit 200 may include an input apparatus and an output apparatus which are not illustrated in the drawing. For example, the CPU 1 executes a computer program (software program, hereinafter, also referred to as just “program”) read by the storage unit 2 so that the function of the control unit 200 is achieved.

The control unit 200 may include a communication interface (I/F) which is not illustrated in the drawing. The control unit 200 may access an external apparatus through the communication interface to determine the image to be projected based on the information acquired from the external apparatus.

It is to be noted that the present invention described using the first exemplary embodiment and respective exemplary embodiments described below as examples is also configured by a non-volatile storage medium, such as a compact disc, which stores such a program. It is to be noted that the control unit 200 may be a dedicated apparatus for executing the above-described function. In addition, the hardware configuration of the control unit 200 is not limited to the above-described structure.

### Effect

The effect of the interface apparatus 1000 according to the first exemplary embodiment will be described. The interface apparatus 1000 can provide a projector capable of projecting bright images at one time in a plurality of directions, in a compact and lightweight apparatus.

The reason is that the image that the interface apparatus 1000 projects is an image formed by diffracting the laser light radiated from the laser source 310 with the element 320. The image formed in this manner is brighter than an image formed by an existing projector. In addition, since the control unit 200 controls the element 320, the interface apparatus 1000 can project images at one time in a plurality of directions.

For example, in the case of Class 2 laser that is permitted by law in Japan, the output of the laser is small, a mere 1 mW (milliwatt). Thus, for example, in the case of green laser light, the light flux is about 0.68 lm (lumen). However, when this is radiated in a 1 cm square area, the illuminance becomes 6800 lx (lux). In the first exemplary embodiment, the interface apparatus 1000 radiates the laser light such that the laser light is focused on one region. Thus, the image projected by the interface apparatus 1000 is bright.

In addition, generally, the existing projector converts a beam shape having a substantially circle shape, which is radiated from a laser source, into a rectangle so as to adapt a planar shape of laser light to a rectangular shape of an intensity-modulation type element. Examples of an optical system that performs the conversion include a homogenizer that homogenizes the intensity of light (diffractive optical element) and a fly-eye lens. Since a part of the laser light is lost when passing through the homogenizer or the fly-eye lens, the intensity of the laser light is decreased during the above-described conversion. In some cases, the intensity of the laser light is decreased by 20 to 30% by the conversion.

In contrast, the interface apparatus 1000 does not need to convert a beam shape like the existing projector. More specifically, fewer optical systems that lose light are required, and thus, in the interface apparatus 1000, the intensity decrease of the laser light inside the apparatus is smaller compared to the existing projector. However, the interface apparatus 1000 may have a configuration for converting the beam shape into a shape of the light-receiving surface of the element 320.

Furthermore, the interface apparatus 1000 has a simple configuration, and thus, the apparatus can be reduced in size and weight. In addition, when the interface apparatus 1000 projects a relatively-simple image as illustrated in FIG. 3, the laser source 310 may have only a monochromatic laser source. Thus, the power consumption is small. It is to be noted that the interface apparatus 1000 radiates laser light adjusted such that a set image is formed at a set formation position, and thus, focusing is not needed. More specifically, in the interface apparatus 1000, an optical system is configured such that an image is formed at a set formation position (projection position) by diffraction called Fraunhofer diffraction. There is a property that an image by Fraunhofer diffraction is focused anywhere on an optical path. Thus, the interface apparatus 1000 does not need focusing. Therefore, the interface apparatus 1000 is suitably applied to, for example, a mobile device (portable device) having a usage pattern in which variation in a distance from the apparatus 1000 to the position on which the image is to be formed is assumed. It is to be noted that, when only a small image is formed at a place sufficiently distant from the element 320, both the Fourier transform lens and the projection lens (second optical system 340) which are arranged closer to the light emission side than the element 320 can be omitted. In fact, the present inventor confirmed that an image is formed at a position distant from the element 320 by 1 to 2 meters in a state where a Fourier transform lens and a projection lens are omitted. However, in the first exemplary embodiment, the interface apparatus 1000 includes an optical system also in consideration of forming an image at an extremely-close position. When an image is formed at such a close position, the image is an image obtained by Fourier transforming an image by the element 320. Assuming that the focal length of the Fourier transform lens is F1 and the focal length of the projection lens is F2, the rate of magnification of the image is F1/F2 (=F1÷F2).

It is also considered that a diffraction grating in which wavelength-level fine irregularities are provided on a surface of a transparent material is used in place of the element 320 in the first exemplary embodiment. In this case, a shape of an image that the interface apparatus 1000 can project is only a shape of an image corresponding to the pattern of the diffraction grating.

In contrast, in the first exemplary embodiment, the control unit 200 detects the subject captured by the image unit 100, determines an image to be projected by the projection unit 300 based on the detected result, and controls the element 320 such that the determined image is formed. At this time, for each of the light-receiving regions included in the element 320, the control unit 200 controls the optical properties thereof. Thus, the control unit 200 can control the element 320 such that the laser light incident on the element 320 is diffracted to form an arbitrary image. Therefore, the interface apparatus 1000 can project an image having an arbitrary shape in an arbitrary direction.

Hereinafter, specific examples of the interface apparatus 1000 will be described. It is assumed that the interface apparatus 1000 in each of the specific examples below has a function of generating control information in accordance with inputted information. For example, information of an object, a movement thereof, or the like is inputted into the interface apparatus 1000 by a picture image by an imaging element, such as a camera, a picture image of a three-dimensional object by a three-dimensional depth detecting element, or the like. The term object here is a product, such as a book, a food product, or a pharmaceutical product, or is a human body, a hand, or a finger. In addition, information of a movement of a person or an object and the like is inputted into the interface apparatus 1000 by an optical sensor, an infrared sensor, or the like. In addition, for example, information representing a state of the interface apparatus 1000 itself is inputted into the interface apparatus 1000 by an electronic compass, a GPS (Global Positioning System), a vibration sensor, an orientation sensor, or the like. In addition, information regarding environment is inputted into the interface apparatus 1000 by a wireless receiver. Examples of the information regarding environment include weather information, traffic information, and location information and product information in a store. Here, there is a case where projection of an image by the interface apparatus 1000 is performed first, and then, information is inputted based on the projected image.

It is to be noted that, when there are regulations regarding output of laser light in a country or a region where the interface apparatus 1000 is used, the interface apparatus 1000 preferably has a function of adjusting the intensity of light (laser light) to be outputted. For example, when the interface apparatus 1000 is used in Japan, the intensity of the laser light outputted from the interface apparatus 1000 is preferably limited to intensity of Class 2 or less.

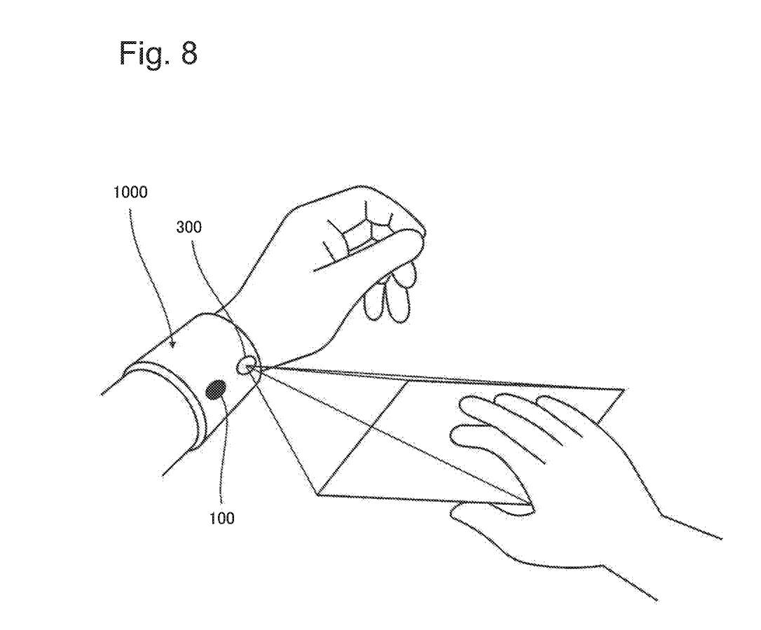

As specific examples, FIG. 8 to FIG. 11 illustrate wearable terminals in which the interface apparatus 1000 is implemented. More specifically, as described above, the interface apparatus 1000 is superior to a conventional projector from the viewpoints of the size, weight, and power consumption. The present inventor thought that the interface apparatus 1000 is used as a wearable terminal with these advantages. It is to be noted that various wearable terminals in which the interface apparatus 1000 is implemented as described below can be achieved by, for example, using a technology of a CPU (Central Processing Unit) board on which ultra-compact optical system and camera are mounted. More specifically, as a technology of reducing the size of a lens, a technology mounted on compact mobile phone, wristwatch-type terminal, eyeglass-type terminal, and the like which have already been in practical use can be used. Such a compact lens is, for example, a plastic lens. In addition, regarding the laser source 310, as shown in, for example, reference literature: Thorlabs Japan Inc., “product information”, [Sep. 26, 2014, Search], Internet (http://www.thorlabs.co.jp/thorproduct.cfm?partnumber=PL520), a compact one has been developed, and a further reduction in size has been promoted. Furthermore, regarding the element 320, a reduction in size is possible by using a technology of reducing the size of a product, as shown in, for example, reference literature: Syndiant Inc., “Technology”, [Sep. 26, 2014, Search], Internet (http://www.syndiant.com/tech_overview.html), and a further reduction in size has been promoted.

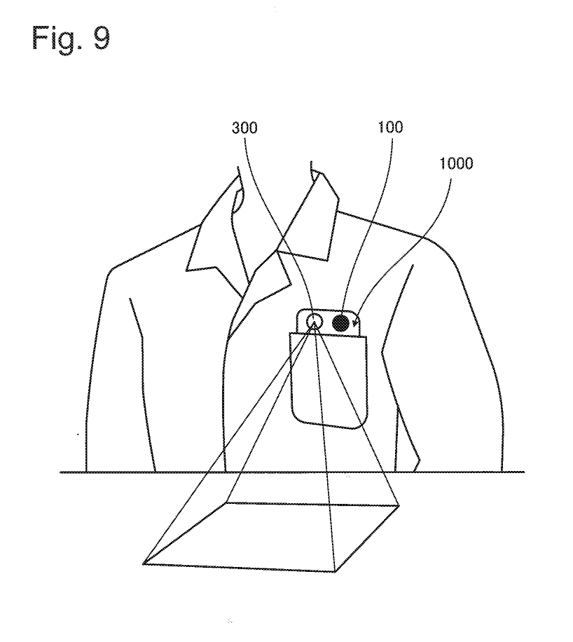

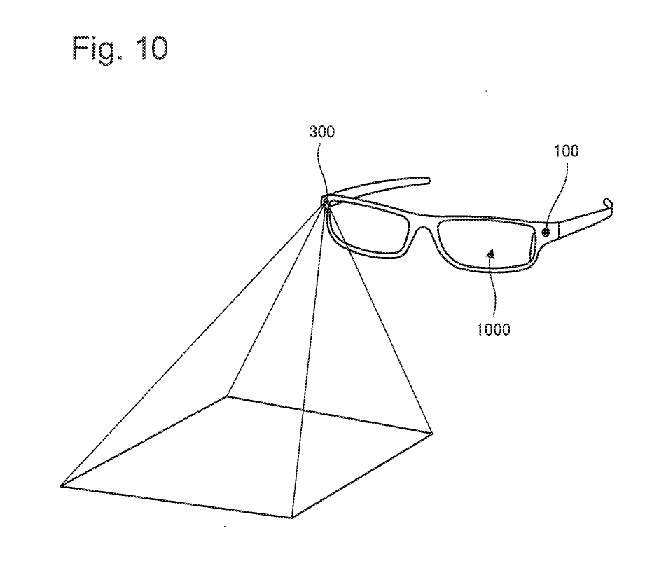

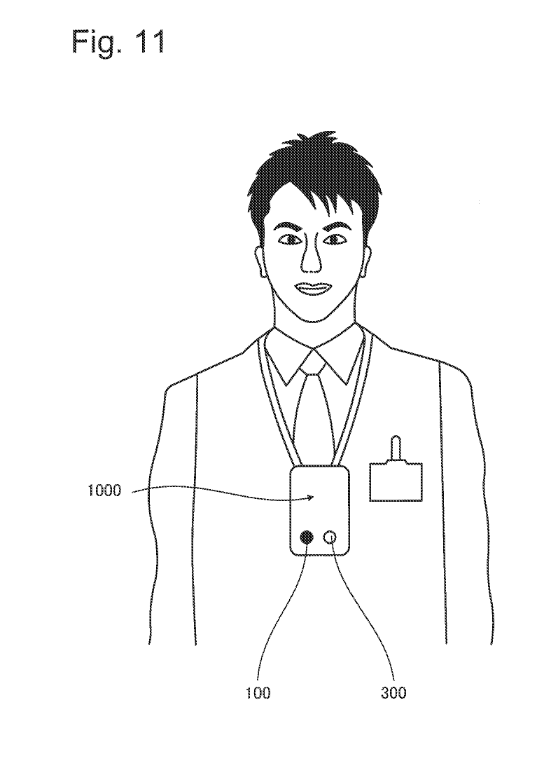

FIG. 8 is a diagram illustrating a wristband in which the interface apparatus 1000 is implemented. FIG. 9 is a diagram illustrating a person having the interface apparatus 1000 in his/her chest pocket. FIG. 10 is a diagram illustrating the interface apparatus 1000 implemented in eyewear, such as eyeglasses and sunglasses. FIG. 11 is a diagram illustrating a person who uses a terminal in which the interface apparatus 1000 is implemented with the terminal dangled around the neck. In addition, the interface apparatus 1000 may be implemented in shoes, a belt, a tie, a hat, or the like, as a wearable terminal.

In the interface apparatuses 1000 illustrated in FIG. 8 to FIG. 11, the image unit 100 and the projection unit 300 are provided to be separated from each other (positions of optical axes are made different). However, the image unit 100 and the projection unit 300 may be designed such that the optical axes are coaxial with each other.

In addition, the interface apparatus 1000 is considered to be used by being dangled from a ceiling or hung on a wall with an advantage of the smallness of the size or the lightness.

The interface apparatus 1000 may be implemented in a portable electronic device, such as a smartphone or a tablet.

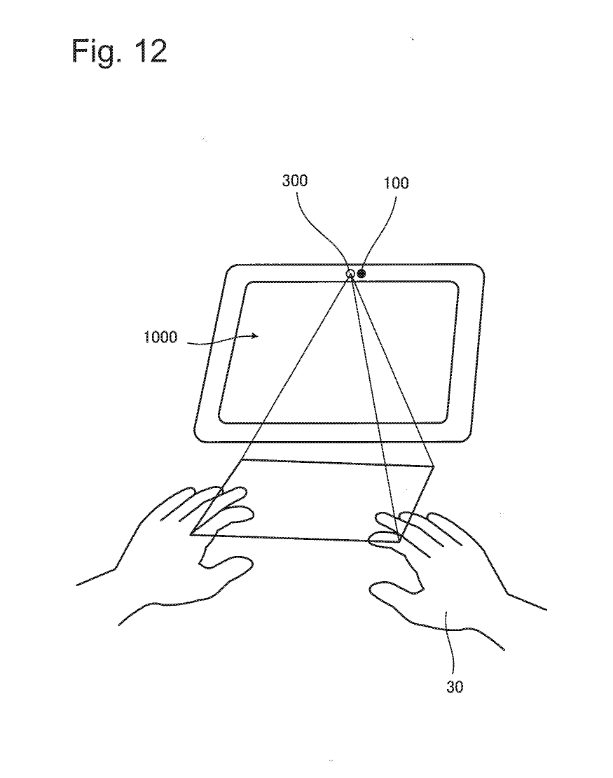

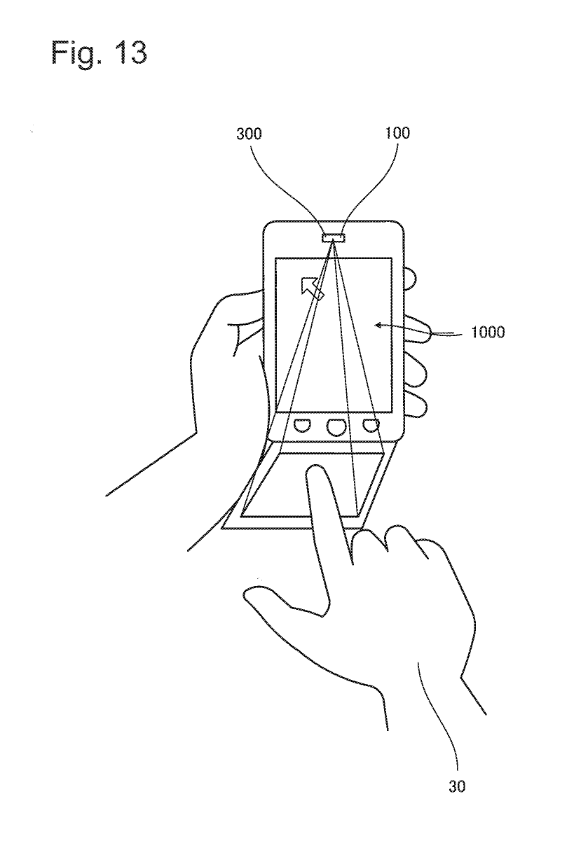

FIG. 12 is a diagram illustrating an example of the interface apparatus 1000 implemented in a tablet terminal. FIG. 13 is a diagram illustrating an example of the interface apparatus 1000 implemented in a smartphone.

The projection unit 300 projects, for example, an image representing an input interface such as a keyboard. A user of the interface apparatus 1000 performs an operation with respect to the image of the keyboard or the like. The image unit 100 captures the image of the keyboard projected by the projection unit 300 and a hand 30 of the user. The control unit 200 identifies the operation that the user has performed with respect to the image of the keyboard from a positional relationship between the captured image of the keyboard and the hand 30 of the user.

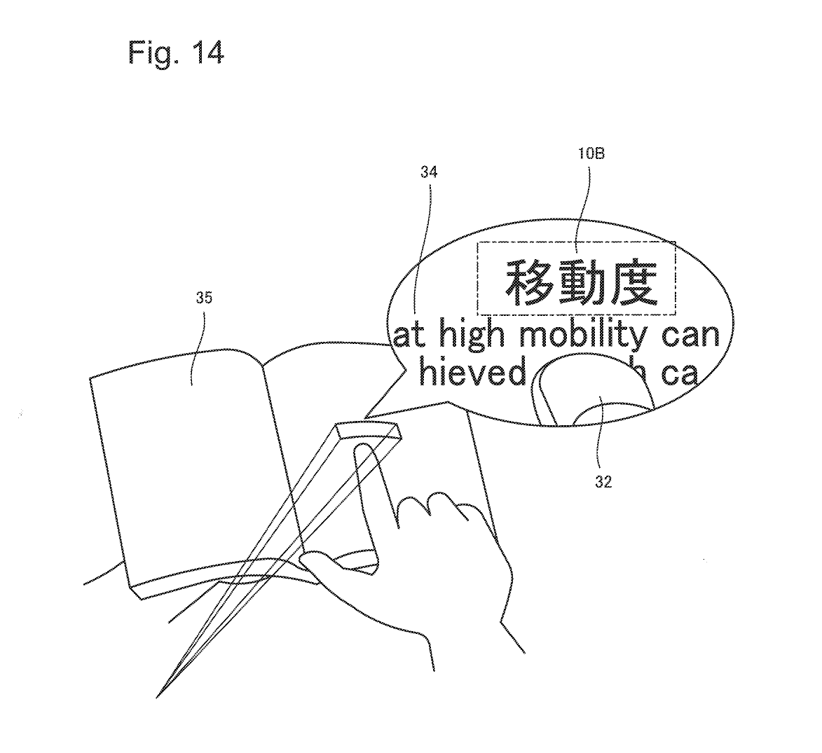

FIG. 14 is a diagram illustrating an example in which the interface apparatus 1000 is applied to a translation support device. A situation where a user who wears the interface apparatus 1000 around the chest reads a book 35 in which an English sentence 34 is printed is assumed. The user wants to know a Japanese translation of the word “mobility”. The user points to the position on which the word “mobility” is printed with a finger 32.

The image unit 100 captures a picture image including the word “mobility” and the finger of the user located close to the word. The control unit 200 detects the English word “mobility” and pointing of the English word with the finger of the user included in the picture image based on the picture image captured by the image unit 100. The control unit 200 acquires information of the Japanese translation of the English word “mobility”. It is to be noted that the control unit 200 may receive the information from an external apparatus that is connected to the interface apparatus 1000 in a communicable way, or may read the information from an internal memory included in the interface apparatus 1000.

The control unit 200 determines a character string shape representing the Japanese translation, as an image 10B to be projected. The control unit 200 determines to project the image 10B on the position of the English word “mobility” printed on the book or in the vicinity of the English word. The control unit 200 controls the optical properties of each of the light-receiving regions of the element 320 such that the image 10B having the character string shape representing the Japanese translation is projected in the vicinity of the English word “mobility” captured by the image unit 100. The element 320 diffracts the incident laser light. The projection unit 300 projects the image 10B in the vicinity of the English word “mobility”. FIG. 14 illustrates a state in which the image 10B having the character string shape representing the Japanese translation is projected in the vicinity of the English word “mobility”.

It is to be noted that a gesture that the control unit 200 detects is not limited to the gesture “pointing of the word with the finger”. The control unit 200 may use detection of another gesture as a trigger of an operation.

When the interface apparatus 1000 is applied to the translation support device, the interface apparatus 1000 needs to project images having various shapes representing translations in accordance with words that the user wants to translate. For example, when the user points to the English word “apple”, the interface apparatus 1000 needs to project an image having a shape representing a character string of a word corresponding to the Japanese translation thereof. Subsequently, when the user points to the English word “grape”, the interface apparatus 1000 needs to project an image having a shape representing a character string of a word corresponding to the Japanese translation thereof. In this manner, the interface apparatus 1000 needs to project images having different shapes one after another in accordance with the words to which the user has pointed.

As described above, since the interface apparatus 1000 can project an image of any shape in any direction, a translation support device as described above, which needs to project images having various shapes, can be achieved.

As described above, the interface apparatus 1000 can project a bright image, and thus, can project a translation with sufficient visibility even in a bright environment in which the user reads a book. In addition, the interface apparatus 1000 is applied to the translation support device, so that, for example, by merely pointing a finger to a word whose translation the user wants to look up, the user can know the translation of the word.

The above-described translation support device can be achieved by, for example, installing a predetermined program on the interface apparatus 1000.

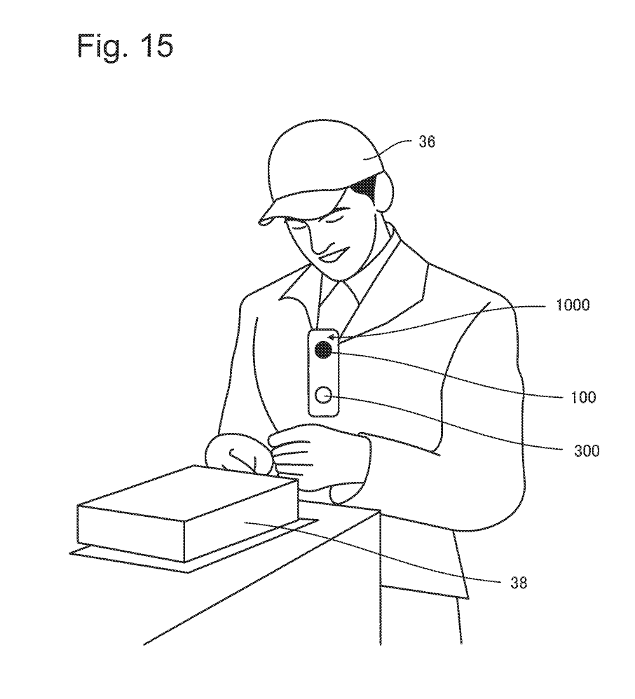

FIG. 15 is a diagram illustrating an example in which the interface apparatus 1000 is applied to a work support device in a factory or the like. A situation where a user 36 who uses the interface apparatus 1000 by wearing the interface apparatus 1000 around his/her neck assembles an electrical appliance 38 in a factory is assumed. It is assumed that the user 36 wants to know a work procedure when assembling the electrical appliance 38.

The image unit 100 captures the electrical appliance 38. The control unit 200 detects the type, the shape, and the like of the electrical appliance 38 based on the picture image captured by the image unit 100. The control unit 200 may acquire information representing the progress of an assembling work of the electrical appliance 38 based on the picture image captured by the image unit 100. In addition, the control unit 200 detects a positional relationship between the own apparatus and the electrical appliance 38 based on the picture image captured by the image unit 100.

The control unit 200 acquires information representing an assembling procedure of the electrical appliance 38 based on the detected result. The control unit 200 may receive the information from an external apparatus that is connected to the interface apparatus 1000 in a communicable way, or may read the information from an internal memory included in the interface apparatus 1000.

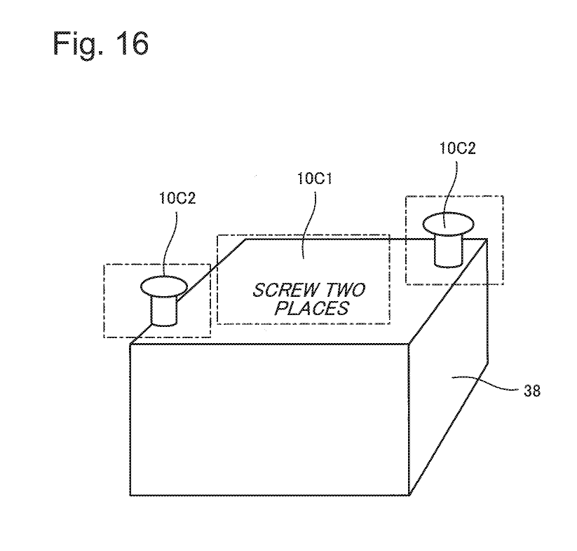

The control unit 200 determines a character string shape or a picture representing the assembling procedure of the electrical appliance 38, as an image 10C to be projected (refer to FIG. 16). The control unit 200 controls the optical properties of each of the plurality of light-receiving regions of the element 320 such that the image 10C is projected on the electrical appliance 38 captured by the image unit 100. The element 320 diffracts the incident laser light. The projection unit 300 projects the image 10C on the position of the electrical appliance 38.

FIG. 16 is a diagram illustrating an example of an image projected by the interface apparatus 1000. As illustrated in FIG. 16, the interface apparatus 1000 projects an image 10C₁ representing that a next step of assembly of the electrical appliance 38 is screwing and images 10C₂ representing places to be screwed so as for the user 36 to visually detect the image 10C₁ and the images 10C₂.

When the interface apparatus 1000 is applied to a work support device, the shape of the image that the interface apparatus 1000 projects is expected to be extremely wide-ranged. This is because a work procedure in a factory or the like varies depending on a product, a progress situation of work, and the like. The interface apparatus 1000 needs to display an appropriate image in accordance with the situation captured by the image unit 100.

As described above, since the interface apparatus 1000 can project an image of any shape in any direction, such a work support device can be achieved.

The interface apparatus 1000 can project a bright image, and thus, can project a work procedure with sufficient visibility even in a bright environment in which a user works.

The above-described work support device can be achieved by, for example, installing a predetermined program on the interface apparatus 1000.

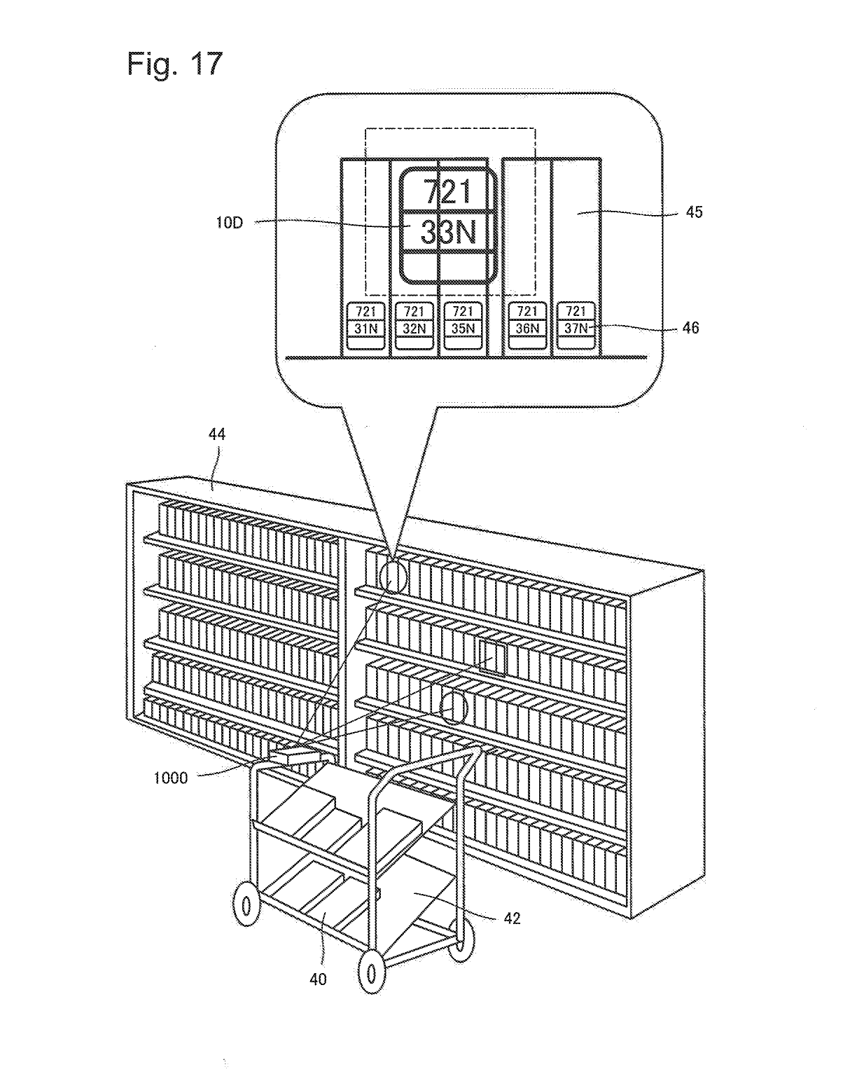

FIG. 17 is a diagram illustrating an example in which the interface apparatus 1000 is applied to a support device of book returning work in a library or the like. A situation where a user (for example, library staff) does work of returning a book 40 to be returned to a shelf 44 of the library is assumed. In FIG. 17, the interface apparatus 1000 is provided on a cart 42 (hand barrow) that carries the book 40 to be returned and the like.

Seals with class numbers 46 are attached to spines of the book 40 to be returned and books 45 stored in the shelf of the library. The class number is a number representing that a book with the number should be stored in which shelf and which position of the library. It is assumed that, in the shelf 44 of the library, books are stored in numerical order of the class numbers. The situation illustrated in FIG. 17 is a situation where a staff looks for a position to which the book 40 with the class number “721/33N” should be returned.

The image unit 100 captures the shelf 44 in which books are stored. The control unit 200 detects the class numbers of the seals attached to the spines of the books 45 stored in the shelf 44 based on the picture image captured by the image unit 100. In the example of FIG. 17, the image unit 100 captures the picture image of the shelf 44 in which the books 45 with the class numbers “721/31N” to “721/35N” are stored. The control unit 200 determines (detects) a storage position of the book to be returned based on the class number “721/33N” of the book 40 that should be returned, the picture image captured by the image unit 100 and a rule that books are stored in numerical order of the class numbers. In addition, the control unit 200 detects a positional relationship between the own apparatus and the determined position based on the picture image captured by the image unit 100. The control unit 200 controls the optical properties of each of the light-receiving regions of the element 320 such that an image (mark) 10D that the user can visually detect is projected on the determined storage position. The projection unit 300 projects the mark image 10D on the determined position.

In the example of FIG. 17, the interface apparatus 1000 projects the image 10D having a character string shape representing the class number “721/33N” of book that should be returned on the determined position. By using the image 10D projected by the interface apparatus 1000 as a mark, the user stores the book 40 to be returned in the position on which the image is projected.

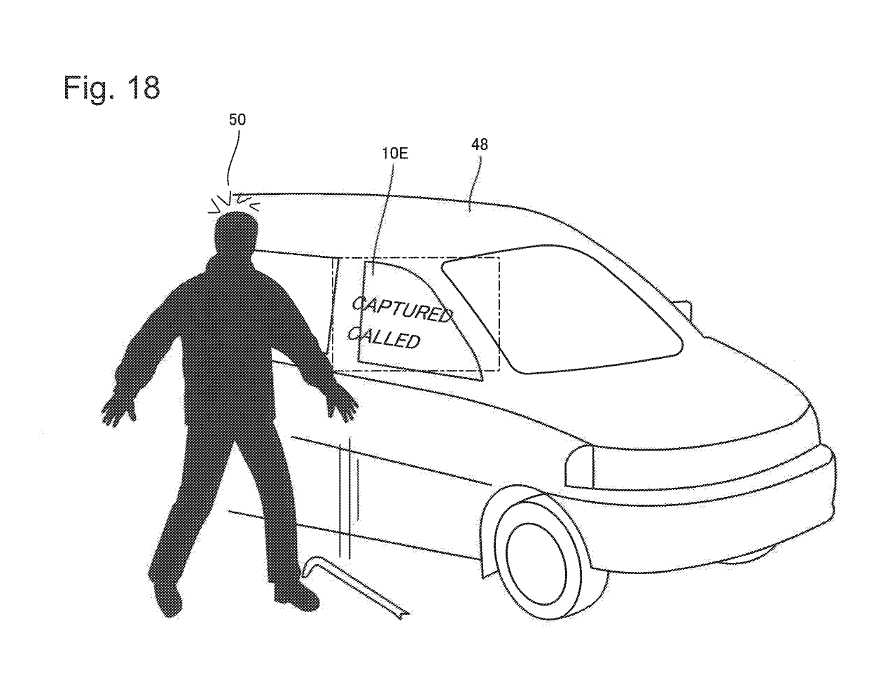

FIG. 18 is a diagram illustrating an example in which the interface apparatus 1000 is applied to a vehicle antitheft device. In FIG. 18, the interface apparatus 1000 is provided at an arbitrary position in a vehicle 48. The interface apparatus 1000 may be provided on a ceiling or a wall of a parking lot. The image unit 100 and the control unit 200 monitor a person 50 who moves toward the vehicle 48 (i.e. the vehicle in which the interface apparatus 1000 is provided). The control unit 200 has a function of detecting a pattern of behavior of the person 50 who moves toward the vehicle 48 and determining whether the person 50 is a suspicious person based on the detected pattern of behavior and information of a pattern of suspicious behavior provided in advance. Then, when determining that the person 50 is a suspicious person, the control unit 200 executes control of projecting an image 10E representing a warning message for the person (suspicious person) 50 on a position that can be visually detected by the person (suspicious person) 50.

In the example of FIG. 18, the interface apparatus 1000 detects the person (suspicious person) 50 who has something like a crowbar. The interface apparatus 1000 projects the image 10E representing a message stating that the face of the person (suspicious person) 50 has been captured and the image 10E representing a message stating that a call to the police has been made on the vehicle 48 so as for the person (suspicious person) 50 to visually detect the image 10E. In addition, the interface apparatus 1000 may image the face of the person (suspicious person) 50 by the image unit 100 and store the face of the person (suspicious person) 50.

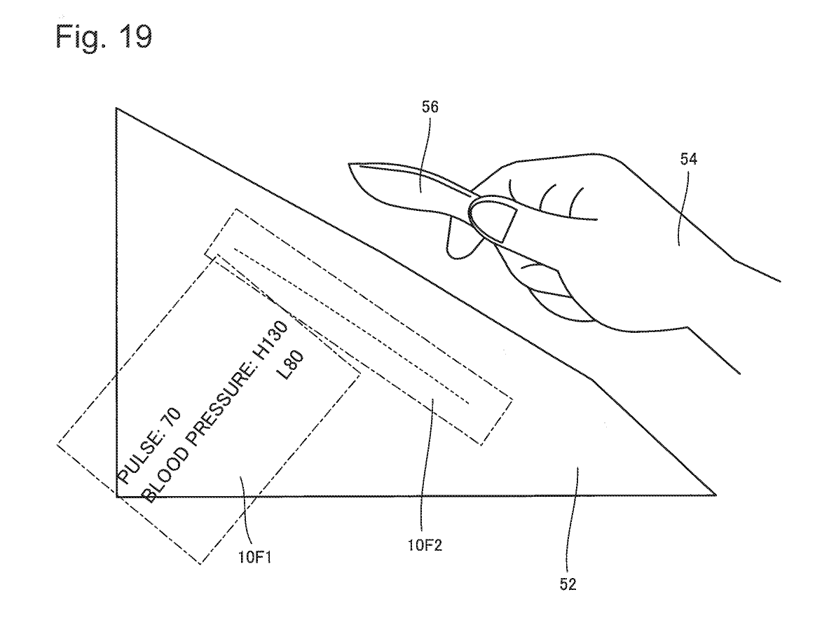

FIG. 19 is a diagram illustrating an example in which the interface apparatus 1000 is applied to a medical device. In the example of FIG. 19, the interface apparatus 1000 projects an image 10F representing medical information on a patient's body 52 so as for a doctor 54 who performs surgery to visually detect the image 10F. In the example, the image 10F representing medical information is an image 10F₁ representing the pulse and blood pressure of the patient and an image 10F₂ representing an area to be incised with a scalpel 56 in the surgery. The interface apparatus 1000 may be fixed to, for example, a ceiling or a wall of a surgery room. In addition, the interface apparatus 1000 may be fixed to doctor's clothes.

In the example, the image unit 100 captures the patient's body. The control unit 200 detects a positional relationship between the own apparatus and the patient's body 52 based on the picture image captured by the image unit 100. The control unit 200 acquires information of the pulse and blood pressure of the patient and information representing the area to be incised. The control unit 200 may receive the information from an external apparatus that is connected to the interface apparatus 1000 in a communicable way, or may read the information from an internal memory included in the interface apparatus 1000. Alternatively, the doctor or the like may input the information from an input unit included in the interface apparatus 1000. The control unit 200 determines the shape of an image to be projected based on the acquired information. In addition, the control unit 200 determines a position on which the image 10F should be displayed based on the positional relationship between the own apparatus and the patient's body 52.

The control unit 200 controls the optical properties of each of the light-receiving regions of the element 320 such that the determined image 10F is displayed on the determined display position. The projection unit 300 projects the image 10F on the determined position.

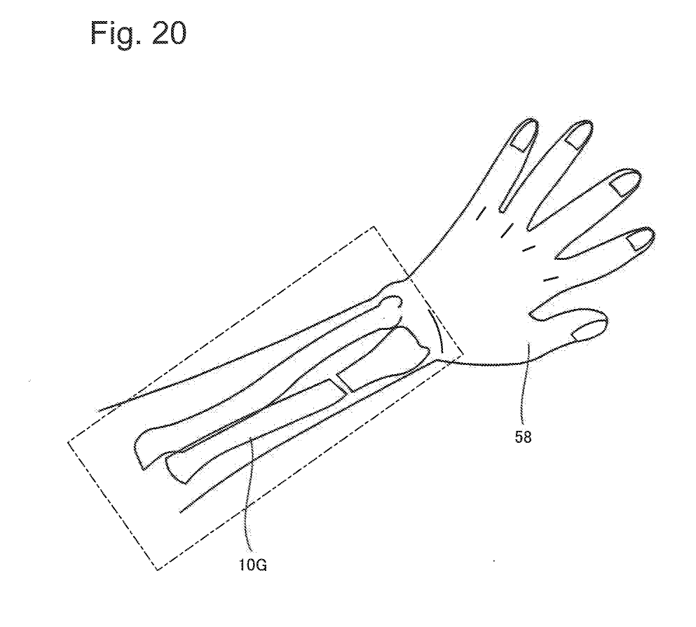

FIG. 20 is a diagram illustrating another example in which the interface apparatus 1000 is applied to a medical device. In the example of FIG. 20, the interface apparatus 1000 projects an image 10G representing a fractured part on a patient's arm 58 based on the information inputted from outside. In the example, the interface apparatus 1000 may be fixed to, for example, a ceiling or a wall of a room. In addition, the interface apparatus 1000 may be fixed to doctor's or patient's clothes.

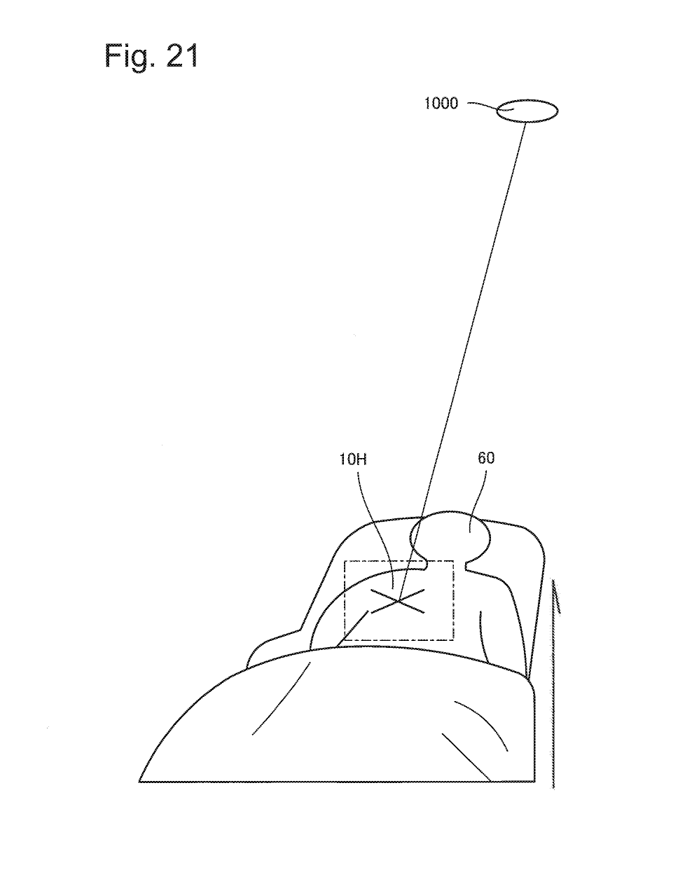

FIG. 21 is a diagram illustrating an example in which the interface apparatus 1000 is applied to emergency medical care. In the example of FIG. 21, the interface apparatus 1000 displays (projects) an image 10H representing an area to be compressed on a body of an emergency patient 60 who needs cardiac massage.

In the example, the interface apparatus 1000 may be fixed to, for example, a ceiling or a wall of a medical ward. In addition, the interface apparatus 1000 may be embedded in, for example, a smartphone or a tablet terminal.

The image unit 100 captures the body of the emergency patient 60. The control unit 200 detects a positional relationship between the own apparatus and the body of the emergency patient 60 based on the picture image captured by the image unit 100. The control unit 200 acquires information representing the area to be compressed in the body of the emergency patient 60. The control unit 200 may receive the information from an external apparatus that is connected to the interface apparatus 1000 in a communicable way, or may read the information from an internal memory included in the interface apparatus 1000. Alternatively, the doctor or the like may input the information from an input unit included in the interface apparatus 1000. Alternatively, the doctor or the like may represent the information from another terminal that is connected to the interface apparatus 1000 through a communication network.

The interface apparatus 1000 may transmit the picture image of the emergency patient 60 captured by the image unit 100 to an external terminal through a communication network. The external terminal is, for example, a terminal that the doctor operates. The doctor checks the picture image of the emergency patient 60 displayed on a display of the external terminal, and represents the area to be compressed. The interface apparatus 1000 receives the information from the external terminal.

The control unit 200 determines a position on which the image 10H representing the area to be compressed should be displayed based on the acquired (received) information and the positional relationship between the own apparatus and the body of the emergency patient 60. The control unit 200 controls the optical properties of each of the light-receiving regions of the element 320 such that the image 10H representing the area to be compressed is projected on the determined position. The projection unit 300 projects the image 10H on the determined position.

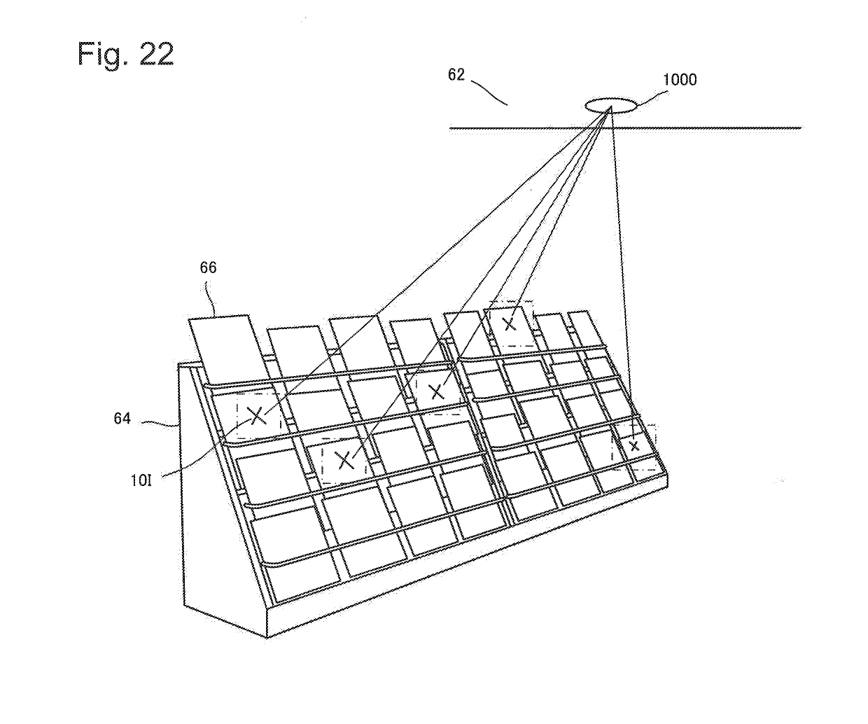

FIG. 22 is a diagram illustrating a specific example in which the interface apparatus 1000 is used for supporting product replacement work in a book store, a convenience store, or the like. In the example of FIG. 22, a product is a magazine 66.

The interface apparatus 1000 is provided on a ceiling 62, and the magazine 66 is put on a magazine shelf 64. There are magazines put on a shelf only during a fixed time period, such as weekly, monthly, or quarterly magazines. Thus, the replacement work of these magazines is frequently performed in a store. The work is usually performed by a person in charge of the work, such as a store clerk. For example, the person in charge of the work selects magazines to be replaced while holding a list of books to be returned, in which magazines to be returned are listed, and comparing a cover of each magazine put on a magazine shelf with the list of books to be returned. The work is laborious work even for a store clerk who is used to the work.

The interface apparatus 1000 can significantly reduce labor required for such product replacement work. In the example, the image unit (camera) 100 of the interface apparatus 1000 captures a cover of the magazine 66. The control unit 200 is provided in advance with information in which the cover of the magazine 66 is associated with a handling deadline of the magazine 66 as magazine management information. The control unit 200 selects the magazine 66 whose handling deadline is approaching or the magazine 66 whose handling deadline is overdue based on the picture image of the cover of each magazine 66 captured by the image unit 100 and the magazine management information. The control unit 200 generates control information representing a direction of the selected magazine 66. Then, the control unit 200 controls the optical properties of each of the light-receiving regions of the element 320 to project an image (book-to-be-returned display mark) 10I that draws attention of the person in charge of the work in the direction of the magazine 66 based on the control information. The projection unit 300 projects the book-to-be-returned display mark 10I in the direction of the magazine 66 based on the control information.

Since the interface apparatus 1000 can display a bright image that is a feature thereof, it becomes easy to adjust the brightness of the image such that the image (book-to-be-returned display mark) 10I is displayed with sufficient visibility even in a place whose environmental light is bright such as a book store or a convenience store. It is to be noted that the interface apparatus 1000 can also project marks different from each other on the cover of the magazine 66 whose handling deadline is approaching and the display of the magazine 66 whose handling deadline is overdue.

By using the interface apparatus 1000 in this manner, the person in charge of the work can perform product replacement by simple work in which books are collected with the help of the book-to-be-returned display mark 10I. Since the person in charge of the work does not need to hold the list of books to be returned and can use both hands, working efficiency of the person in charge of the work is significantly increased.

It is to be noted that a method for inputting information into the interface apparatus 1000 may be a method other than capturing with a camera. For example, an IC (Integrated Circuit) tag is embedded in each magazine 66, and an IC tag reader and an apparatus for transmitting information read by the IC tag reader are provided in the magazine shelf 64. A function of acquiring the information transmitted from the apparatus is provided in the interface apparatus 1000. Accordingly, the interface apparatus 1000 receives the information acquired from the IC tag embedded in each magazine 66 as input information and can generate control information based on the information.

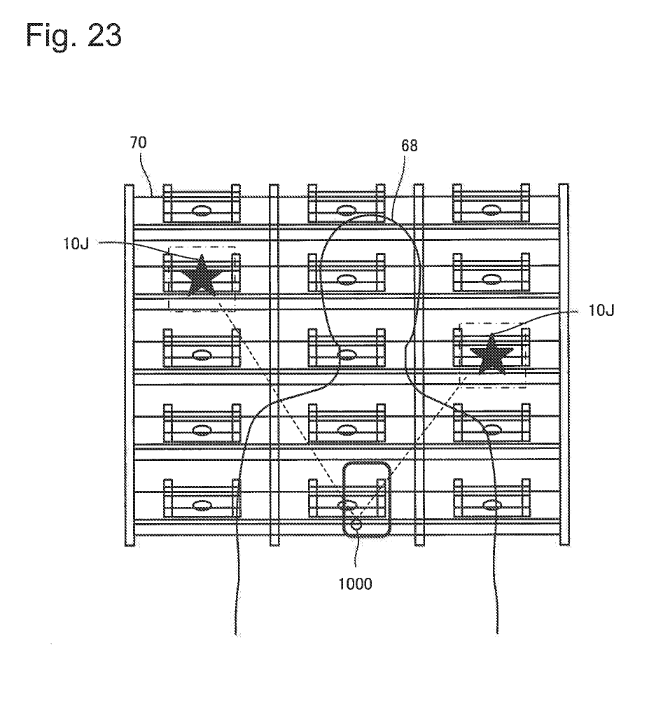

FIG. 23 is a diagram illustrating a specific example in which the interface apparatus 1000 supports work to select a target article from a plurality of articles in a shelf. For example, in a pharmacy, a store clerk sees a prescription supplied by a customer and selects a target medicine from a plurality of medicines in a shelf. In addition, in a factory, a worker selects a target component from a plurality of components in a shelf. In such a shelf, for example, several dozen to several hundred drawers are provided. Thus, the worker must select a drawer containing a target article from a lot of drawers with the help of a label or the like attached to each drawer.

In the example, the interface apparatus 1000 supports such work. It is to be noted that, in the example, the worker 68 is considered to use the interface apparatus 1000 embedded in a mobile device. For example, the worker 68 uses the mobile device with the mobile device dangled around the neck. As described above, the interface apparatus 1000 is compact, and thus, can be embedded in the mobile device.

The interface apparatus 1000 includes the image unit (camera) 100, and information is inputted from the camera. The description is provided by assuming use in a pharmacy. Firstly, data obtained from a prescription is inputted into the interface apparatus 1000 in advance. Then, when the worker 68 stands in front of a medicine shelf, the image unit 100 reads a label attached to each drawer 70 using the camera. Then, the control unit 200 compares the data obtained from the prescription and the label read from the camera to generate control information representing a direction of the drawer 70 on which an image should be projected. The control unit 200 controls the optical properties of each of the light-receiving regions of the element 320 based on the control information. The projection unit 300 projects an image (display mark) 10J toward the drawer 70. The display mark 10J is an image that draws attention of the worker 68.

By using the interface apparatus 1000, the worker 68 can obtain the target article only by opening the drawer 70 on which the display mark 10J is projected. There is no need to search for a target drawer from a lot of drawers or to memorize positions of the drawers so as to increase working efficiency. In addition, human error such as mix-up of articles is reduced. Furthermore, since a note representing a target article such as the prescription in the example or the like does not need to be held, the worker 68 can use both hands. Thus, working efficiency is increased.

It is to be noted that a method in which the interface apparatus 1000 receives the input of information may be a method using an IC tag or the like.

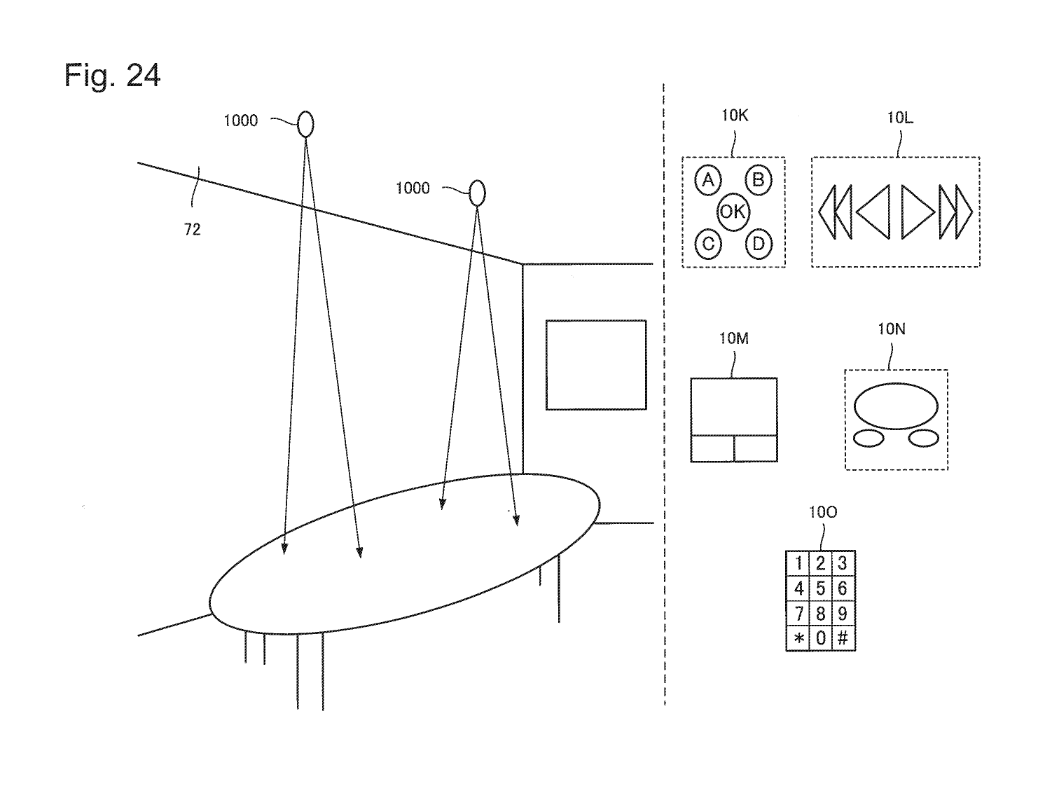

FIG. 24 is a diagram illustrating a specific example in which the interface apparatus 1000 supports a presentation in a meeting room. When a presentation is made in a meeting room, an operation of a projector for projecting a picture image on a screen is usually performed with one PC (Personal Computer). A presenter progresses meeting while operating the PC. Switching of picture image is performed by a mouse click. In a large meeting room, the presenter often stands at a position distant from the PC, and moves so as to operate the PC. The movement of the presenter at every operation of the PC is bothersome for the presenter, and moreover, is obstructive to the progress of the meeting.

By using the interface apparatus 1000, the botheration like this is reduced, and the meeting can be made to be smoothly progressed. In this case, a single or a plurality of the interface apparatuses 1000 are provided on a ceiling 72 depending on the size of the meeting room. The interface apparatus 1000 receives the input of information using the image unit (camera) 100. For example, the interface apparatus 1000 monitors a movement of each of participants who participate in the meeting, and projects, for example, images 10K to 10O on a meeting table at the participant's request. The participant presents his/her own request by making a gesture set in advance, for example, raising his/her palm upward. The interface apparatus 1000 detects the movement using the image unit 100. Then, the control unit 200 generates control information representing an image that should be projected and a direction in which the image should be projected based on the detected gesture. The control unit 200 controls the optical properties of each of the light-receiving regions of the element 320 based on the control information. The projection unit 300 projects an image that meets the participant's request.

For example, the image 10K is a menu selection screen. By selecting a desired button therein, picture images of the images 10L to 10O can be selected. For example, the image 10L represents a button for advancing and returning a page. The image 10M and the image 10N represent mouse pads. In addition, the image 10O represents a numeric keypad. For example, the interface apparatus 1000 detects operations with respect to these images by meeting participants using the camera. For example, when a participant performs an operation to push a button for advancing a page, the interface apparatus 1000 transmits indication for advancing a page to the PC. The PC receives the indication to advance a page. It is to be noted that a function of detecting an operation of a participant with respect to an image and a function of transmitting indication to the PC may be provided outside the interface apparatus 1000.

By using the interface apparatus 1000 in this manner, a virtual interface environment can be provided by the input of information by a gesture and the output of information using an image. The meeting participant can perform an operation of a screen whenever he/she chooses without getting up from a chair. Thus, the interface apparatus 1000 can contribute to time shortening and efficiency promotion of the meeting.

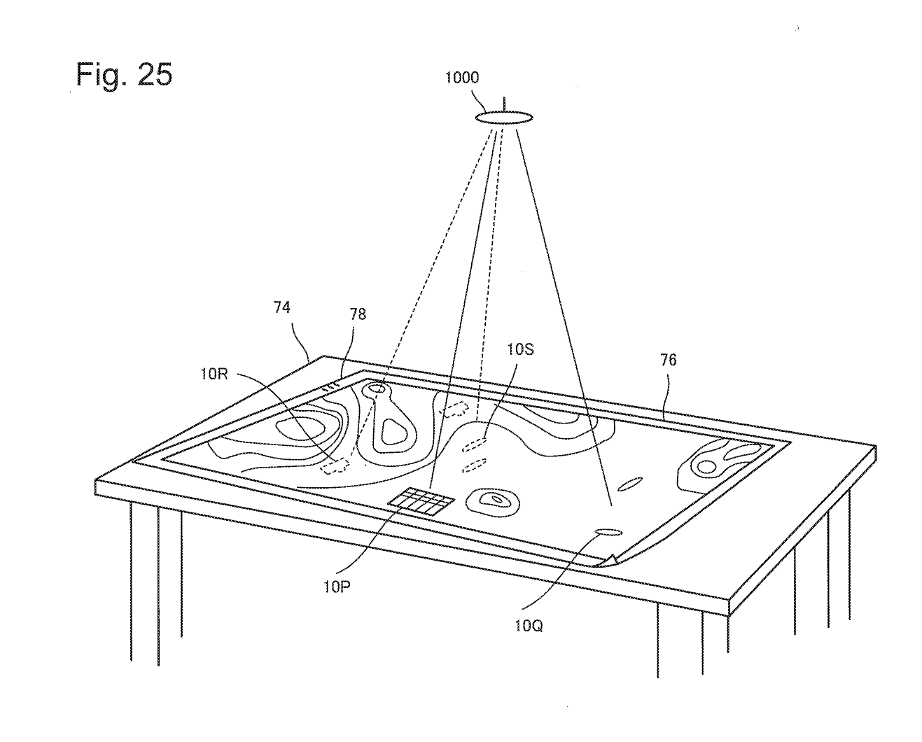

FIG. 25 is a diagram illustrating a specific example in which a meeting environment is created at a visiting destination by using the interface apparatus 1000 embedded in a mobile device. It can be considered that a variety of places, such as a room other than a meeting room, in a tent, and beneath a tree, are changed to a simple meeting place. In the example, in order to share information by spreading a map, the interface apparatus 1000 creates a simple meeting environment. It is to be noted that, also in the example, the interface apparatus 1000 receives information using the image unit (camera) 100.

The mobile device in which the interface apparatus 1000 is embedded is hung at a somewhat high position. In the example, a table 74 is placed under the interface apparatus 1000, and a map 76 is spread on the table 74. The interface apparatus 1000 detects the map 76 by the image unit 100. Specifically, the interface apparatus 1000 reads an identifying code 78 on the map and detects the map 76 based on the identifying code 78. By projecting an image on the map 76, the interface apparatus 1000 makes various kinds of information be projected (displayed) on the map.

More specifically, the control unit 200 determines where on the map 76 and what image should be projected. The control unit 200 controls the optical properties of each of the light-receiving regions of the element 320 based on the determination. The projection unit 300 projects the image determined by the control unit 200 at the determined display position on the map 76.

For example, the interface apparatus 1000 projects an image 10P (image of operation pad), an image 10Q (image of ship), an image 10R (image representing building), and an image 10S (image of ship). The information that the interface apparatus 1000 should project may be stored inside the interface apparatus 1000 or may be collected using the Internet and wireless communication.

As described above, the interface apparatus 1000 has low power consumption and is compact. Thus, the interface apparatus 1000 can be operated with a battery. As a result, a user of the interface apparatus 1000 can carry the interface apparatus 1000 to various places and create the meeting environment or the like at the places. It is to be noted that an image that the interface apparatus 1000 projects does not need focusing, and thus, a visible image can be projected even on a cured place or a rugged object. In addition, the interface apparatus 1000 enables bright display, and thus, can be used in a bright environment. More specifically, the interface apparatus 1000 satisfies a precondition in the use of mobiles, not selecting an environment.

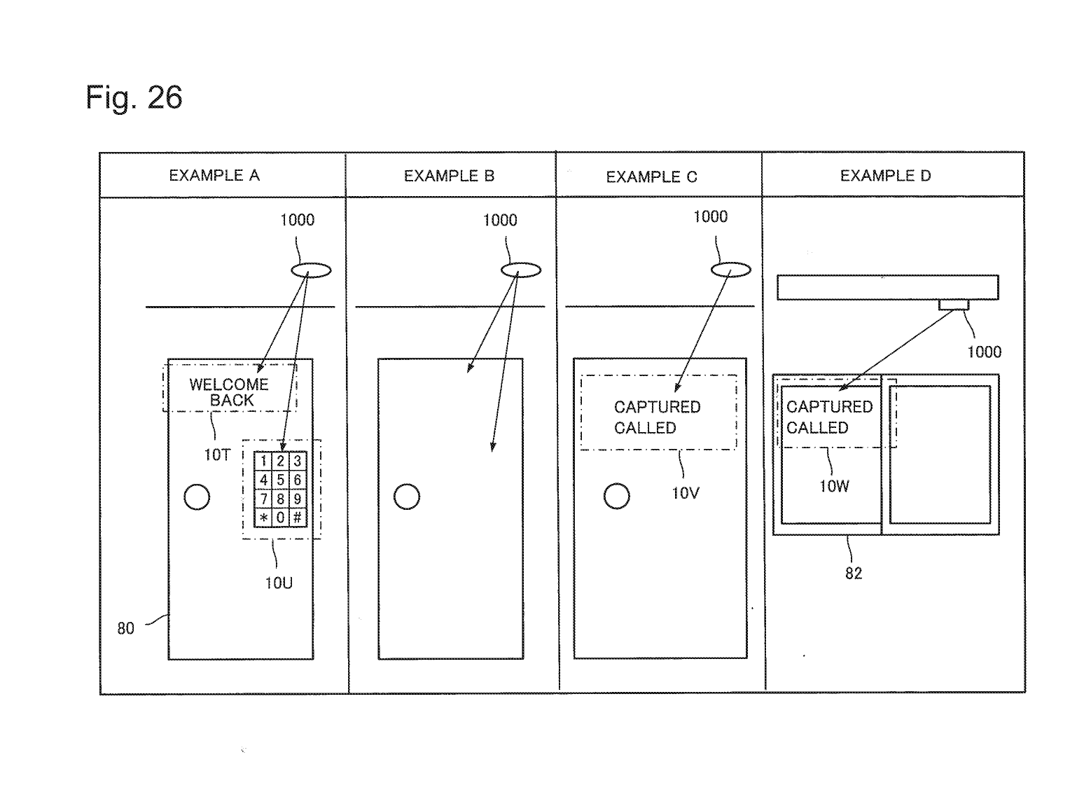

FIG. 26 is a diagram illustrating a specific example in which the interface apparatus 1000 is applied to an entering/leaving management system. For example, in a house, the interface apparatus 1000 provided on a ceiling of an entrance 80, eaves, or the like monitors a person and a movement thereof.

Regarding room entering management, a database of persons having a qualification for room entering is created in advance. When entering a room, personal authentication, such as a face authentication, fingerprint authentication, or iris authentication function, is performed by the interface apparatus 1000 or another apparatus. The control unit 200 controls the optical properties of each of the light-receiving regions of the element 320 by using the control information generated based on the result of the personal authentication. The projection unit 300 projects images, such as images 10U to 10W, illustrated in examples A to D in FIG. 26.

The example A is a specific example of the case of responding to a person having a qualification for room entering. The interface apparatus 1000 projects an image 10T representing a message, for example. In addition, the interface apparatus 1000 projects an image 10U representing a password input pad. The image unit 100 captures, for example, a picture image in which a finger of a person overlaps with the image 10U, and the control unit 200 acquires, based on the picture image, information regarding an operation that the person performs for the image 10U.

The example B is a specific example of the case of responding to a general visitor. In this case, the interface apparatus 1000 does not perform anything. For example, a usual reception system such as an intercom is used.

The example C is a specific example of the case of responding to a suspicious person. When a movement to forcibly trespass such as picking is detected, the interface apparatus 1000 projects an image 10V representing a warning to fight off a suspicious person. In addition, the interface apparatus 1000 may further make a call to a security company or the like.

The example D is a specific example of the case of fighting off a suspicious person who tries to enter from a window. Although there is an existing system for fighting off a suspicious person by detecting vibration caused by breaking a window, a suspicious person can be fought off before a window is broken by using the interface apparatus 1000.

A projected picture image in the example will be further described. If an image 10W illustrated in FIG. 26 is tried to be displayed on a window 82 using a general projector, a fairly large apparatus needs to be provided. In the interface apparatus 1000, since laser light passes through the window 82 and is difficult to be reflected in the window 82, if the whole of the image 10W is tried to be displayed on the window 82 only by laser light radiated from one laser source, the image 10W may become somewhat dark. For this reason, in the example, light radiated from separate laser sources may form, for example, characters or keys one by one in a state where the light is not spread and a reduction in the brightness is small. In this case, the interface apparatus 1000 has a plurality of laser sources. Accordingly, the interface apparatus 1000 can display the image 10W on the window 82 more brightly.

By using the interface apparatus 1000 as in the example, entering a room is possible without a key, and the effect of fighting off a suspicious person can be expected.

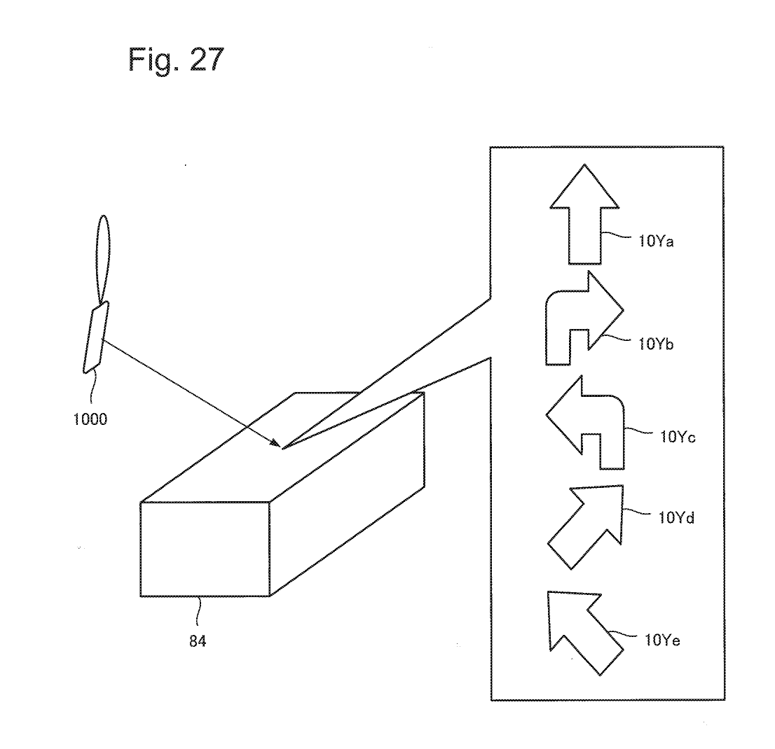

FIG. 27 is a diagram illustrating a specific example in which the interface apparatus 1000 is used for supporting a delivery business. When delivering a package to an unfamiliar place, a deliverer needs to move while checking a traveling direction with a map. However, the deliverer usually holds the package with both hands, and thus, both hands are often occupied. In addition, when a delivery destination is an overly complicated place, even if both hands are not occupied, it is sometimes difficult to read the traveling direction from the map.

By displaying a direction in which the deliverer should travel as an image, the interface apparatus 1000 of the example supports the delivery business. For example, the deliverer dangles the interface apparatus 1000 from his/her neck. Here, it is assumed that the interface apparatus 1000 includes a GPS. In addition, it is assumed that the control unit 200 has a function of generating control information by determining the traveling direction using location information and map data acquired from the GPS. It is to be noted that the GPS and the function of generating control information using the GPS may be provided outside the interface apparatus 1000. The control unit 200 controls the optical properties of each of the light-receiving regions of the element 320 based on the control information. The projection unit 300 projects images 10Ya to 10Ye representing the traveling direction on the surface of a package 84 that the deliverer holds.

For example, the interface apparatus 1000 includes the image unit (camera) 100, and detects a direction of the package that the deliverer holds. It is to be noted that the images representing the traveling direction may be projected at the deliverer's feet or the like. By seeing the images (arrows) 10Ya to 10Ye projected on the package 84, the deliverer can know the traveling direction without checking the map.

By using the interface apparatus 1000 in this manner, the deliverer does not need to deposit the package to see and check the map. Thus, the interface apparatus 1000 can obtain effects of time shortening of a delivery operation and a reduction in botheration due to the delivery operation.

### Second Exemplary Embodiment

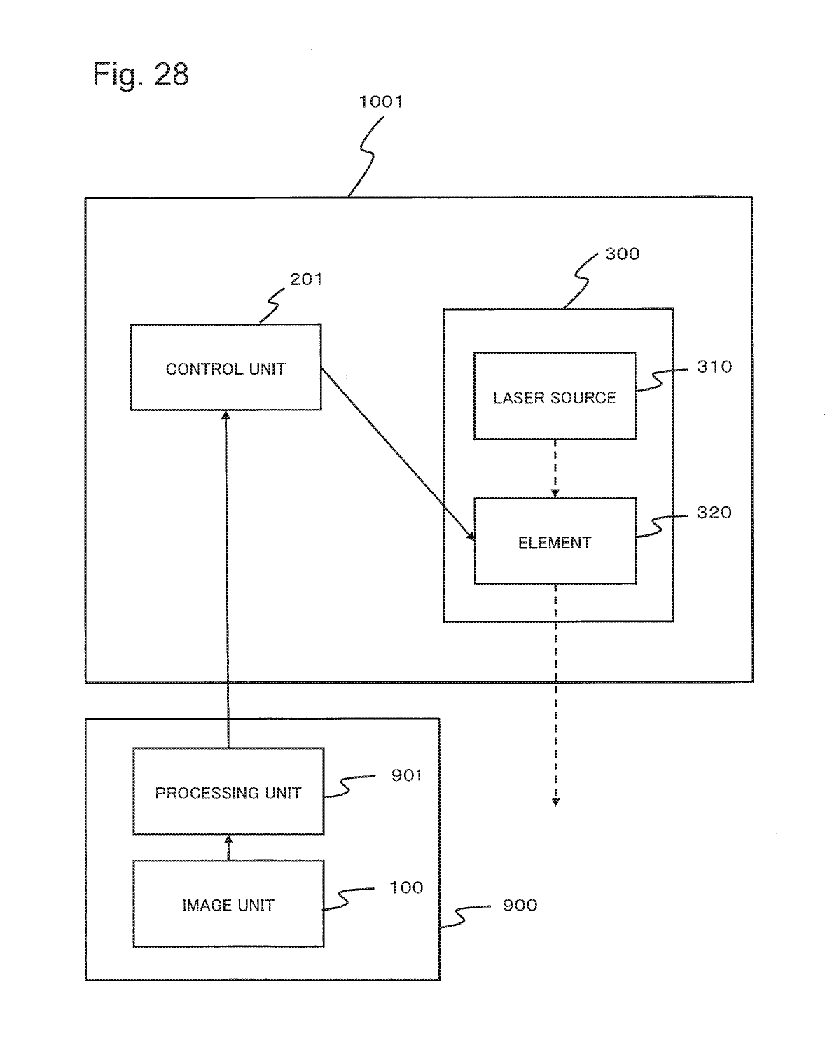

FIG. 28 is a block diagram illustrating a functional configuration of a module of a second exemplary embodiment according to the present invention. In FIG. 28, each block represents a configuration of a functional unit for the convenience of description rather than a configuration of a hardware unit. In FIG. 28, a dotted line represents a flow of laser light, and a solid line represents a flow of information. Configurations that are substantially the same as the configurations illustrated in FIG. 1 are denoted by the same reference numerals, and the description thereof is omitted.

A module 1001 has a control unit 201 and the projection unit 300 including the laser source 310 and the element 320. The projection unit 300 may further include the first optical system 330 and the second optical system 340 in addition to the laser source 310 and the element 320.

The module 1001 is a component used by being connected to an electronic device 900 having a function corresponding to the image unit 100, such as a smartphone and a tablet terminal. The electronic device 900 includes the function corresponding to the image unit 100 and a processing unit 901 that executes image recognition processing for a captured picture image.

The control unit 201 determines an image to be formed by the light emitted from the element 320 based on the information representing a detected result by the processing unit 901, and controls the element 320 such that the determined image is formed. The electronic device 900 connected to the module 1001 can include a function similar to that of the interface apparatus 1000 of the first exemplary embodiment.

### Third Exemplary Embodiment

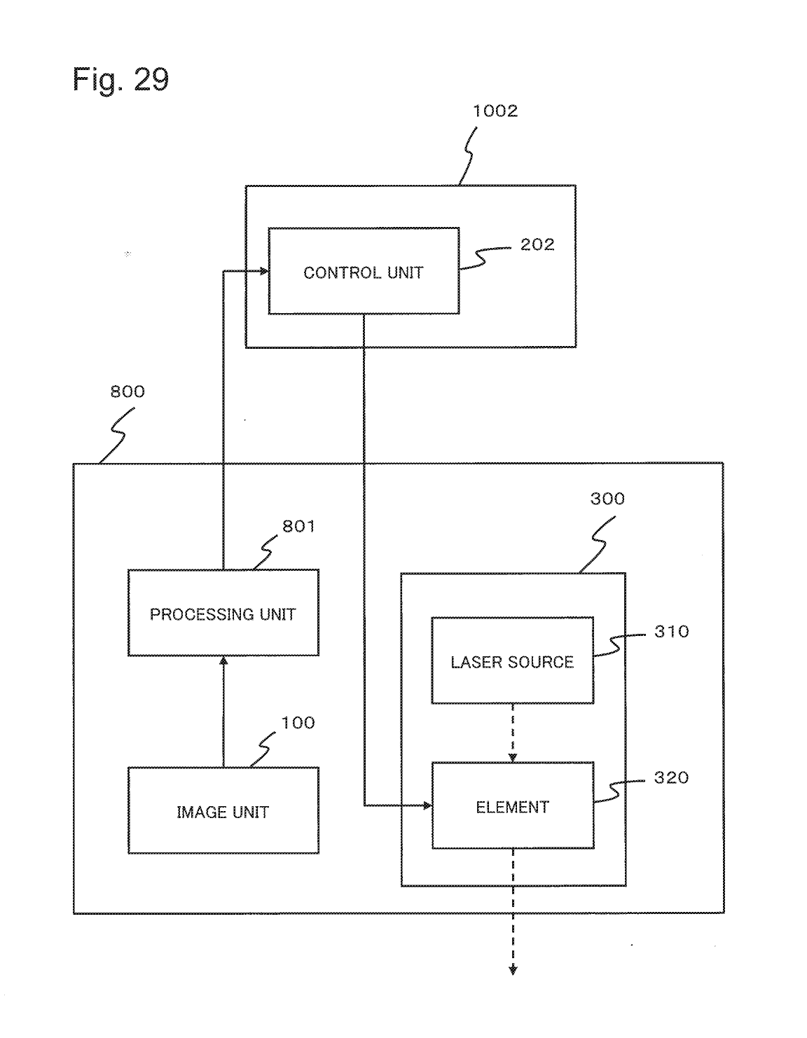

FIG. 29 is a block diagram illustrating a functional configuration of an electronic component of a third exemplary embodiment according to the present invention. In FIG. 29, each block represents a configuration of a functional unit for the convenience of description rather than a configuration of a hardware unit. In FIG. 29, a dotted line represents a flow of laser light, and a solid line represents a flow of information. Configurations that are substantially the same as the configurations illustrated in FIG. 1 are denoted by the same reference numerals, and the description thereof is omitted.

An electronic component 1002 includes a control unit 202. The electronic component 1002 is a component used by being connected to an electronic device 800. The electronic device 800 includes a function corresponding to the image unit 100 and the projection unit 300, and a processing unit 801 that executes image recognition processing for a captured picture image.

The control unit 202 determines an image to be formed by the light emitted from the element 320 based on the information representing a detected result by the processing unit 801, and controls the element 320 such that the determined image is formed. The electronic device 800 connected to the electronic component 1002 can include a function similar to that of the interface apparatus 1000 of the first exemplary embodiment.

### Fourth Exemplary Embodiment

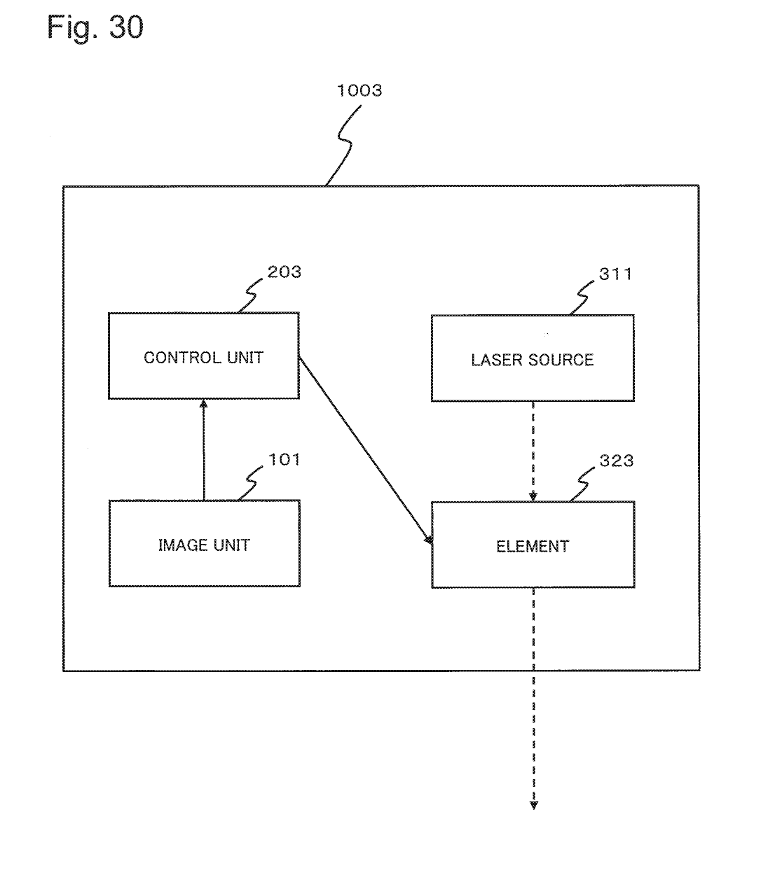

FIG. 30 is a block diagram illustrating an interface apparatus of a fourth exemplary embodiment according to the present invention. In FIG. 30, each block represents a configuration of a functional unit for the convenience of description rather than a configuration of a hardware unit. In FIG. 30, a dotted line represents a flow of laser light, and a solid line represents a flow of information.

An interface apparatus 1003 includes a laser source 311, an element 323, an image unit 101, and a control unit 203.

The laser source 311 radiates laser light. When the laser light is incident, the element 323 modulates a phase of the laser light and emits the modulated laser light. The image unit 101 captures a subject. The control unit 203 detects the subject captured by the image unit 101, determines an image to be formed by the laser light emitted from the element 320 based on the detected result, and controls the element 323 such that the determined image is formed.

Heretofore, the exemplary embodiments of the present invention have been described, but the above-described exemplary embodiments are those for the purpose of easy understanding of the present invention, not for limitedly interpreting the present invention. The present invention can be changed and modified without departing from the scope thereof, and equivalents thereof are included in the present invention.

This application is based upon and claims the benefit of priority from Japanese patent application No. 2013-207107, filed on Oct. 2, 2013, the disclosure of which is incorporated herein in its entirety by reference.

A part or all of the above-described exemplary embodiments can be described as the following supplementary notes, but are not limited to the following.

### (Supplementary Note 1)

An interface apparatus includes:
a laser source that radiates laser light;
an element that, when the laser light is incident by the laser source, modulates a phase of the laser light and emits modulated light;
an image unit that captures an image of a subject; and
a control unit that detects the subject captured by the image unit, determines an image to be formed by the laser light emitted from the element based on a detected result, and controls the element such that a determined image is formed.

### (Supplementary Note 2)

In the interface apparatus according to supplementary note 1,
the element has a plurality of light-receiving regions, and each of the light-receiving regions modulates the phase of the laser light incident thereon and emits the modulated laser light, and,
the control unit controls the element such that a parameter that determines a difference between the phase of the laser light incident on the light-receiving region and a phase of the laser light emitted from the light-receiving region is changed with respect to each of the light-receiving regions.

### (Supplementary Note 3)

In the interface apparatus according to supplementary note 1 or 2,
the element is a phase-modulation type diffractive optical element.

### (Supplementary Note 4)

In the interface apparatus according to supplementary note 2,
a refractive index of the light-receiving region is changed depending on a voltage applied to the light-receiving region, and
the control unit controls the voltage to be applied to each of the light-receiving regions of the element such that the determined image is formed.

### (Supplementary Note 5)

In the interface apparatus according to supplementary note 2,
the element includes a substrate and a plurality of mirrors,
each of the plurality of light-receiving regions of the element is configured by the mirror, and
the control unit controls a distance between the substrate and the mirror.

### (Supplementary Note 6)

In the interface apparatus according to any one of supplementary notes 1 to 5,
the element emits the laser light such that, in a region that the image unit images, the image is formed over one or a plurality of partial regions that are one region of the region.

### (Supplementary Note 7)

In the interface apparatus according to any one of supplementary notes 1 to 5,
the element emits the laser light such that the image is formed over the subject captured by the image unit.

### (Supplementary Note 8)

In the interface apparatus according to supplementary note 7,
the control unit generates information on a positional relationship between an own apparatus and the subject based on the detected result, and controls the element such that the determined image is formed over the subject based on the information on the positional relationship.

### (Supplementary Note 9)

A portable electronic device includes
the interface apparatus according to any one of supplementary notes 1 to 8.

### (Supplementary Note 10)

An accessory includes
the interface apparatus according to any one of supplementary notes 1 to 8.

### (Supplementary Note 11)

A module that is used by being incorporated in an electronic device including an image unit that captures an image of a subject and a processing unit that detects the subject captured by the image unit is provided, and the module includes:
a laser source that radiates laser light;
an element that, when the laser light is incident by the laser source, modulates a phase of the laser light and emits modulated laser light; and
a control unit that determines an image to be formed by the laser light emitted from the element based on a detected result by the processing unit, and controls the element such that a determined image is formed.

### (Supplementary Note 12)

In the module according to supplementary note 12,
the element has a plurality of light-receiving regions, and each of the light-receiving regions modulates the phase of the laser light incident thereon and emits the modulated laser light, and,
the control unit controls the element such that a parameter that determines a difference between the phase of the laser light incident on the light-receiving region and a phase of the laser light emitted from the light-receiving region is changed with respect to each of the light-receiving regions.

### (Supplementary Note 13)

In the module according to supplementary note 11 or 12,
the element is a phase-modulation type diffractive optical element.

### (Supplementary Note 14)

In the module according to supplementary note 12,
a refractive index of the light-receiving region is changed depending on a voltage applied to the light-receiving region, and
the control unit controls the voltage to be applied to each of the light-receiving regions of the element such that the determined image is formed.

### (Supplementary Note 15)

In the module according to supplementary note 12,
the element includes a substrate and a plurality of mirrors,
each of the plurality of light-receiving regions of the element is configured by the mirror, and
the control unit controls a distance between the substrate and the mirror.

### (Supplementary Note 16)

In the module according to any one of supplementary notes 11 to 15,
the element emits the laser light such that, in a region that the image unit images, the image is formed over one or a plurality of partial regions that are one region of the region.

### (Supplementary Note 17)

In the module according to any one of supplementary notes 11 to 15,
the element emits the laser light such that the image is formed over the subject captured by the image unit.

### (Supplementary Note 18)

In the module according to supplementary note 17,
the control unit generates information on a positional relationship between an own apparatus and the subject based on the detected result, and controls the element such that the determined image is formed over the subject based on the information on the positional relationship.

### (Supplementary Note 19)

An electronic component that controls an electronic device includes:
a laser source that radiates laser light;
an element that, when the laser light is incident by the laser source, modulates a phase of the laser light and emits modulate laser light;
an image unit that captures an image of a subject; and
a processing unit that detects the subject imaged by the image unit, wherein
the electronic component determines an image to be formed by the laser light emitted from the element based on a detected result by the processing unit, and controls the element such that a determined image is formed.

### (Supplementary Note 20)

In the electronic component according to supplementary note 19,
the element has a plurality of light-receiving regions, and each of the light-receiving regions modulates the phase of the laser light incident thereon and emits the modulated laser light, and,
the electronic component controls the element such that a parameter that determines a difference between the phase of the laser light incident on the light-receiving region and a phase of the laser light emitted from the light-receiving region is changed with respect to each of the light-receiving regions.

### (Supplementary Note 21)

In the electronic component according to supplementary note 20,
a refractive index of the light-receiving region is changed depending on a voltage applied to the light-receiving region, and
the electronic component controls the voltage to be applied to each of the light-receiving regions of the element such that the determined image is formed.

### (Supplementary Note 22)

In the electronic component according to supplementary note 20,
the element includes a substrate and a plurality of mirrors,
each of the plurality of light-receiving regions of the element is configured by the mirror, and
the electronic component controls a distance between the substrate and the mirror.

### (Supplementary Note 23)

In the electronic component according to any one of supplementary notes 19 to 22,
the electronic component controls the element such that, in a region that the image unit images, the image by the laser light emitted from the element is formed over one or a plurality of partial regions that are one region of the region.

### (Supplementary Note 24)

In the electronic component according to any one of supplementary notes 19 to 22,
the electronic component controls the element emits such that the image by the laser light emitted from the element is formed over the subject captured by the image unit.

### (Supplementary Note 25)

In the electronic component according to supplementary note 24,
the electronic component generates information on a positional relationship between an own apparatus and the subject based on the detected result, and controls the element such that the determined image is formed over the subject based on the information on the positional relationship.

### (Supplementary Note 26)

A control method, which is executed by a computer that controls an interface apparatus including a laser source that radiates laser light, an element that, when the laser light is incident by the laser source, modulates a phase of the laser light and emits modulated laser light, and an image unit that captures an image of a subject, includes:
detecting the subject captured by the image unit;
determining an image emitted from the element based on the a detected result; and
controlling the element such that a determined image is formed.

### (Supplementary Note 27)

In the control method according to supplementary note 26,
the element has a plurality of light-receiving regions, and each of the light-receiving regions modulates the phase of the laser light incident thereon and emits the modulated laser light, and,
the control method controls the element such that a parameter that determines a difference between the phase of the laser light incident on the light-receiving region and a phase of the laser light emitted from the light-receiving region is changed with respect to each of the light-receiving regions.

### (Supplementary Note 28)

In the control method according to supplementary note 27,
a refractive index of the light-receiving region is changed depending on a voltage applied to the light-receiving region, and
the electronic component controls the voltage to be applied to each of the light-receiving regions of the element such that the determined image is formed.

### (Supplementary Note 29)

In the control method according to supplementary note 27,
the element includes a substrate and a plurality of mirrors,
each of the plurality of light-receiving regions of the element is configured by the mirror, and
the control method controls a distance between the substrate and the mirror.

### (Supplementary Note 30)

In the control method according to any one of supplementary notes 26 to 29,
the control method controls the element such that, in a region that the image unit images, the image by the laser light emitted from the element is formed over one or a plurality of partial regions that are one region of the region.

### (Supplementary Note 31)

In the control method according to any one of supplementary notes 26 to 29,
the control method controls the element emits such that the image by the laser light emitted from the element is formed over the subject captured by the image unit.

### (Supplementary Note 32)

In the control method according to supplementary note 31,
the control method generates information on a positional relationship between an own apparatus and the subject based on the detected result, and controls the element such that the determined image is formed over the subject based on the information on the positional relationship.

### (Supplementary Note 33)

A program makes a computer execute a set of processing to controls an interface apparatus including a laser source that radiates laser light, an element that, when the laser light is incident by the laser source, modulates a phase of the laser light and emits modulated laser light, and an image unit that captures an image of a subject. The set of processing includes:
detecting the subject captured by the image unit;
determining an image to be formed by the laser light emitted from the element based on a detected result; and
controlling the element such that a determined image is formed.

### (Supplementary Note 34)

In the program according to supplementary note 33,
the element has a plurality of light-receiving regions, and each of the light-receiving regions modulates the phase of the laser light incident thereon and emits the modulated laser light, and,
the program executes computer a processing to control the element such that a parameter that determines a difference between the phase of the laser light incident on the light-receiving region and a phase of the laser light emitted from the light-receiving region is changed with respect to each of the light-receiving regions.

### (Supplementary Note 35)

In the program according to supplementary note 33,
a refractive index of the light-receiving region is changed depending on a voltage applied to the light-receiving region, and
the program executes computer a processing to control the voltage to be applied to each of the light-receiving regions of the element such that the determined image is formed.

### (Supplementary Note 36)

In the program according to supplementary note 34,
the element includes a substrate and a plurality of mirrors,
each of the plurality of light-receiving regions of the element is configured by the mirror, and
the program executes computer a processing to control a distance between the substrate and the mirror.

### (Supplementary Note 37)

In the program according to any one of supplementary notes 33 to 36,
the program executes computer a processing to control the element such that, in a region that the image unit images, the image by the laser light emitted from the element is formed over one or a plurality of partial regions that are one region of the region.

### (Supplementary Note 38)

In the program according to any one of supplementary notes 33 to 36,
the program executes computer a processing to control the element emits such that the image by the laser light emitted from the element is formed over the subject captured by the image unit.

### (Supplementary Note 39)

In the program according to supplementary note 38,
the program executes computer a processing to generate information on a positional relationship between an own apparatus and the subject based on the detected result, and a processing to control the element such that the determined image is formed over the subject based on the information on the positional relationship

### INDUSTRIAL APPLICABILITY

For example, the present invention can be used for achieving a projector that is compact and lightweight, and can project bright images at one time in a plurality of directions.

### REFERENCE SIGNS LIST

### 1 CPU

2 storage unit
10 image
20 subject
30 hand
32 finger
34 English sentence
36 user
38 electrical appliance
40 book
42 cart
44 shelf
46 class number
48 vehicle
50 person
52 patient's body
54 doctor
56 scalpel
58 patient's arm
60 emergency patient
62 ceiling
64 magazine shelf
66 magazine
68 worker
70 drawer
72 ceiling
74 table
76 map
78 identifying code
80 entrance
82 window
84 package
100 image unit
200 control unit
201 control unit
300 projection unit
310 laser source
320 element
321 substrate
322 mirror
330 first optical system
340 second optical system
1000 interface apparatus
1001 module
1002 control component
1003 interface apparatus

What is claimed is:

1. An interface apparatus comprising:
a laser source that radiates laser light;
an element that modulates a phase of incident laser light by the laser source and emits modulated laser light;
an imaging device that captures an image of a subject; and
a controller that detects the subject captured by the imaging device, determines an image to be formed by the laser light emitted from the element based on a detected result, and controls the element such that a determined image is formed.

2. The interface apparatus according to claim 1, wherein
the element has a plurality of light-receiving regions, and each of the plurality of light-receiving regions is configured to modulate the phase of the laser light incident thereon and emit the modulated laser light, and,
the controller controls each of the plurality of light-receiving regions in the element so as to change a difference between the phase of the laser light incident on the light-receiving region and the phase of the laser light emitted from the light-receiving region.

3. The interface apparatus according to claim 1, wherein
the element is a phase-modulation type diffractive optical element.

4. The interface apparatus according to claim 2, wherein
a refractive index of the light-receiving region is changed depending on a voltage applied to the light-receiving region, and
the controller controls the voltage to be applied to each of the light-receiving regions of the element such that the determined image is formed.

5. The interface apparatus according to claim 2, wherein
the element includes a substrate and a plurality of mirrors,
each of the plurality of light-receiving regions of the element is configured by the mirror, and
the controller controls a distance between the substrate and the mirror.

6. The interface apparatus according to claim 1, wherein
the element emits the laser light such that the determined image is formed over one or a plurality of partial regions of a region over which the imaging device captures.

7. The interface apparatus according to claim 1, wherein
the element emits the laser light such that the determined image is formed over the subject captured by the imaging device.

8. The interface apparatus according to claim 7, wherein
the controller generates information on a positional relationship between an own apparatus and the subject based on the detected result, and controls the element such that the determined image is formed over the subject based on the information on the positional relationship.

9. A portable electronic device comprising
the interface apparatus according to claim 1.

10. An accessory comprising
the interface apparatus according to claim 1.

11. A module comprising:
a laser source that radiates laser light;
an element that modulates a phase of incident laser light by the laser source and emits modulated laser light; and
a controller that controls the element,
wherein the controller determines an image to be formed by the modulated laser light emitted from the element and controls the element such that a determined image is formed based on a detected result by processing unit included in an electronic device, the electronic device further including an imaging device that captures an image of a subject, the processing unit detecting the subject captured by the imaging device.

12. An electronic component comprising:
a controller that controls an electronic device, the electronic device including a laser source that radiates laser light, an element that modulates a phase of incident laser light by the laser source and emits modulated laser light, an imaging device that captures an image of a subject, and processing unit that detects the subject captured by the imaging device,
wherein the controller determines an image to be formed by the emitted laser light of the element based on a detected result by the processing unit, and controls the element such that the determined image is formed.

13. (canceled)

14. (canceled)
